(19) United States
(12) Patent Application Publication
(10) Pub. No.: US 2024/0297701 A1
(43) Pub. Date: Sep. 5, 2024

(54) CHANNEL STATE INFORMATION REPORTING USING CODEBOOKS

(71) Applicant: QUALCOMM Incorporated, San Diego, CA (US)

(72) Inventors: Hyojin LEE, San Diego, CA (US); Yu ZHANG, San Diego, CA (US); Alexandros MANOLAKOS, Escondido, CA (US); Wanshi CHEN, San Diego, CA (US); Hwan Joon KWON, San Diego, CA (US)

(21) Appl. No.: 18/575,678

(22) PCT Filed: Aug. 31, 2021
(86) PCT No.: PCT/CN2021/115516

§ 371 Date: Dec. 29, 2023

(51) Int. Cl. H04B 7/06; H04B 7/0456

(52) U.S. Cl. CPC H04B 7/0626; H04B 7/0469; H04B 7/0486

(57) ABSTRACT

Various aspects of the present disclosure generally relate to wireless communication. In some aspects, a user equipment (UE) may determine one or more parameters for a rank 5-8 Type-I codebook. The UE may perform, to a base station, a rank 5-8 channel state information (CSI) reporting based at least in part on the rank 5-8 Type-I codebook that includes the one or more parameters. Numerous other aspects are described.

### FIELD OF THE DISCLOSURE

Aspects of the present disclosure generally relate to wireless communication and to techniques and apparatuses for channel state information (CSI) reporting using codebooks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory; and one or more processors, coupled to the memory, configured to: determine one or more parameters for a rank 5-8 Type-I codebook; and perform, to a base station, a rank 5-8 channel state information (CSI) reporting based at least in part on the rank 5-8 Type-I codebook that includes the one or more parameters.

In some implementations, a method of wireless communication performed by a UE includes determining one or more parameters for a rank 5-8 Type-I codebook; and performing, to a base station, a rank 5-8 CSI reporting based at least in part on the rank 5-8 Type-I codebook that includes the one or more parameters.

In some implementations, a non-transitory computer-readable medium storing a set of instructions for wireless communication includes one or more instructions that, when executed by one or more processors of a UE, cause the UE to: determine one or more parameters for a rank 5-8 Type-I codebook; and perform, to a base station, a rank 5-8 CSI reporting based at least in part on the rank 5-8 Type-I codebook that includes the one or more parameters.

In some implementations, an apparatus for wireless communication includes means for determining one or more parameters for a rank 5-8 Type-I codebook; and means for performing, to a base station, a rank 5-8 CSI reporting based at least in part on the rank 5-8 Type-I codebook that includes the one or more parameters.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a Long Term Evolution (LTE)/New Radio (NR) Type-I single-panel codebook design, in accordance with the present disclosure.

FIG. 4 is a diagram illustrating an example of supported configurations of (N₁, N₂) and (O₁, O₂), in accordance with the present disclosure.

FIGS. 5-8 are diagrams illustrating examples of Type-I single-panel codebooks, in accordance with the present disclosure.

FIG. 9 is a diagram illustrating an example of a maximum number of bits for feedback, in accordance with the present disclosure.

FIG. 10 is a diagram illustrating an example associated with channel state information (CSI) reporting using codebooks, in accordance with the present disclosure.

FIGS. 11-14 are diagrams illustrating examples associated with codebooks for CSI reporting with beam-specific co-phasing factors, in accordance with the present disclosure.

FIG. 15 is a diagram illustrating an example associated with multiple antenna groups, in accordance with the present disclosure.

FIGS. 16-19 are diagrams illustrating examples associated with codebooks for CSI reporting with a double co-phasing structure, in accordance with the present disclosure.

FIGS. 20-23 are diagrams illustrating examples associated with codebooks for CSI reporting with a favorable angular property, in accordance with the present disclosure.

FIGS. 24-31 are diagrams illustrating examples associated with codebooks for CSI reporting with a beam selection capability, in accordance with the present disclosure.

FIG. 32 is a diagram illustrating an example of an NR multiple-input multiple-output (MIMO) Type-I multi-panel codebook design, in accordance with the present disclosure.

FIG. 33 is a diagram illustrating an example of an NR MIMO Type-I multi-panel codebook design, in accordance with the present disclosure.

FIG. 34 is a diagram illustrating an example of supported configurations of (N_{g}, N₁, N₂) and (O₁, O₂), in accordance with the present disclosure.

FIGS. 35-36 are diagrams illustrating examples associated with codebooks for CSI reporting in a multi-panel antenna configuration, in accordance with the present disclosure.

FIGS. 37-42 are diagrams illustrating examples associated with codebooks for CSI reporting in a multi-panel antenna configuration, in accordance with the present disclosure.

FIG. 43 is a diagram illustrating an example of antenna configurations supported by a Type-I multi-panel rank 5-8 codebook, in accordance with the present disclosure.

FIGS. 44-51 are diagrams illustrating examples associated with codebooks for CSI reporting in a multi-panel antenna configuration with a different co-phasing technique, in accordance with the present disclosure.

FIG. 52 is a diagram illustrating an example process associated with CSI reporting using codebooks, in accordance with the present disclosure.

FIG. 53 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

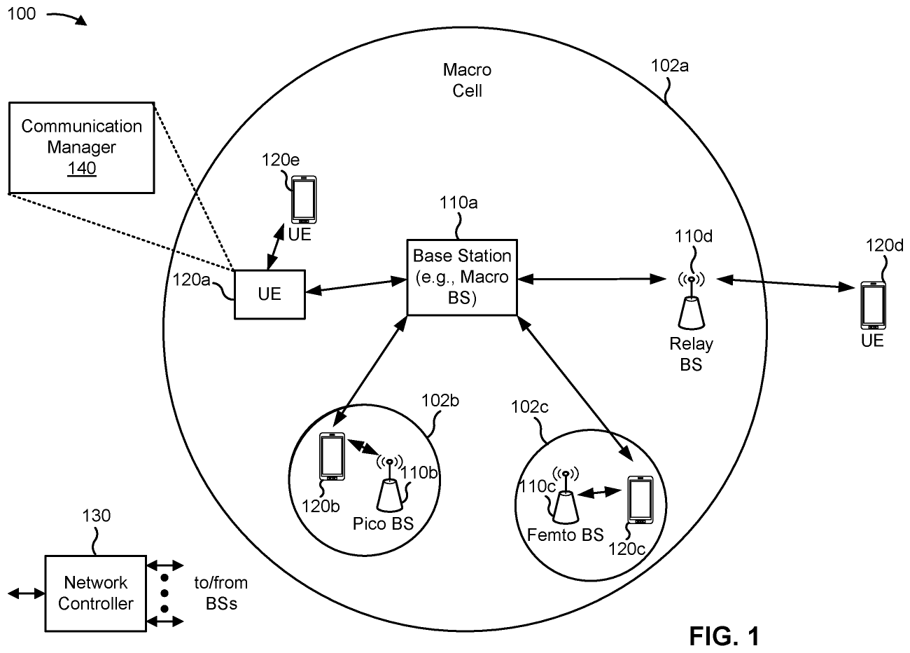

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may determine one or more parameters for a rank 5-8 Type-I codebook; and perform, to a base station, a rank 5-8 channel state information (CSI) reporting based at least in part on the rank 5-8 Type-I codebook that includes the one or more parameters. Additionally, or alternatively, the communication manager 140 may perform one or more other operations described herein.

As indicated above, FIG. 1 is provided as an example. Other examples may differ from what is described with regard to FIG. 1.

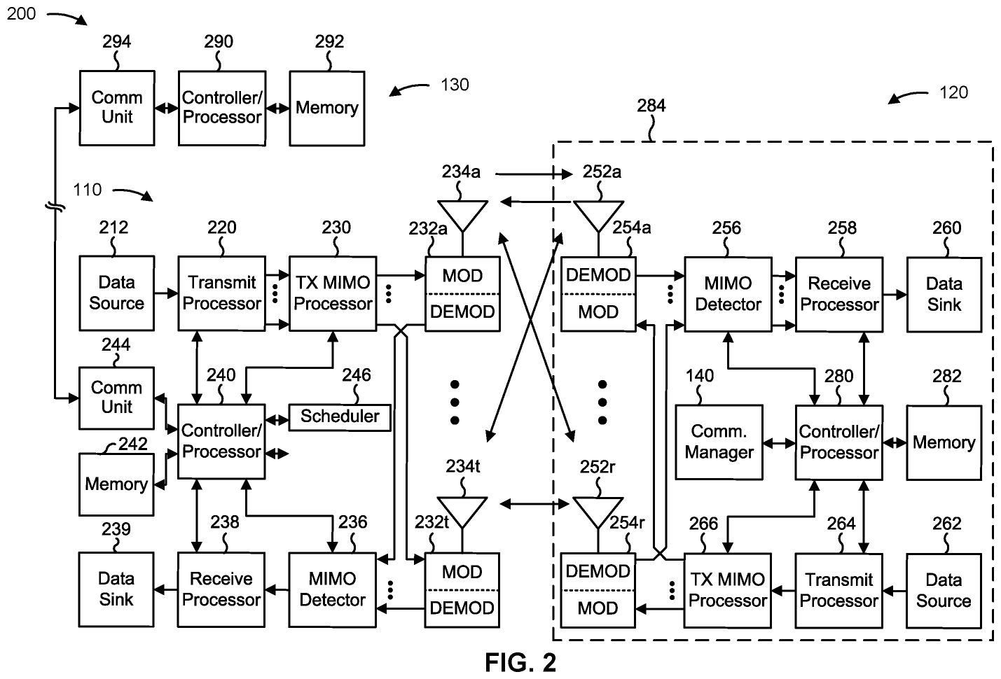

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

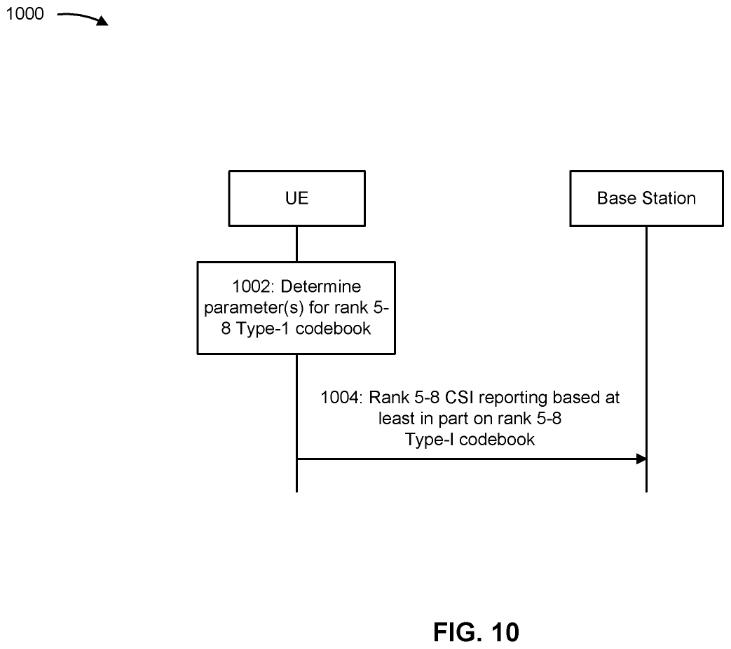

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 10-53).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 10-53).

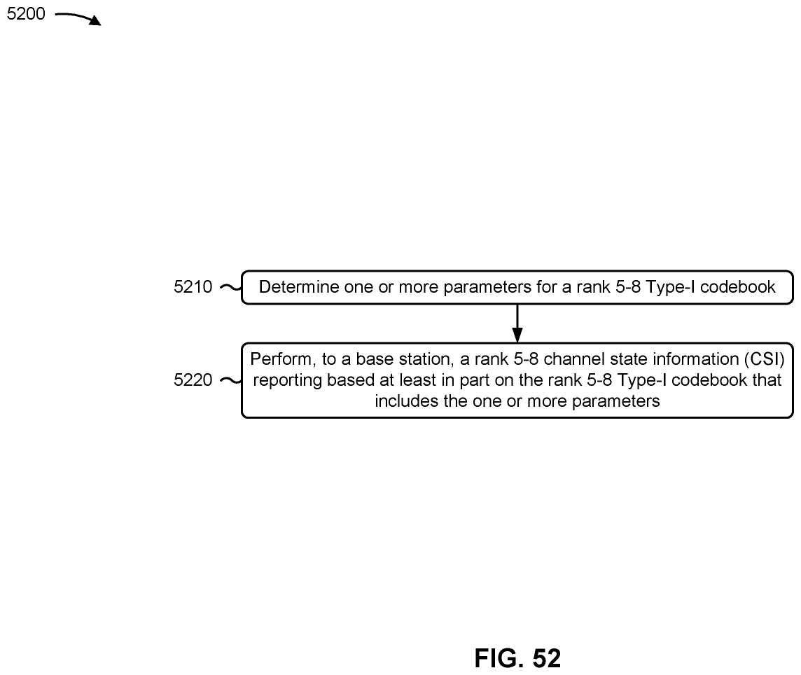

The controller/processor 240 of the base station 110, the controller/processor 280 of the UE 120, and/or any other component(s) of FIG. 2 may perform one or more techniques associated with CSI reporting using codebooks, as described in more detail elsewhere herein. For example, the controller/processor 240 of the base station 110, the controller/processor 280 of the UE 120, and/or any other component(s) of FIG. 2 may perform or direct operations of, for example, process 5200 of FIG. 52, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 5200 of FIG. 52, and/or other processes as described herein. In some examples, executing instructions may include running the instructions, converting the instructions, compiling the instructions, and/or interpreting the instructions, among other examples.

In some aspects, a UE (e.g., UE 120) includes means for determining one or more parameters for a rank 5-8 Type-I codebook; and/or means for performing, to a base station, a rank 5-8 CSI reporting based at least in part on the rank 5-8 Type-I codebook that includes the one or more parameters. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A downlink Type-I single-panel codebook type may be associated with 2, 4, 8, 12, 16, 24, or 32 ports and rank 1-8 (or rank 1, rank 2, and so on until rank 8). A downlink Type-I multi-panel codebook type may be associated with 8, 16, or 32 ports and rank 1-4 (or rank 1, rank 2, and so on until rank 4). A downlink Type-II codebook type may be associated with 4, 8, 12, 16, 24, or 32 ports and rank 1-4. A downlink Type-II port selection codebook type may be associated with 4, 8, 12, 16, 24, or 32 ports and rank 1-4. A “rank” may indicate a number of transmit layers.

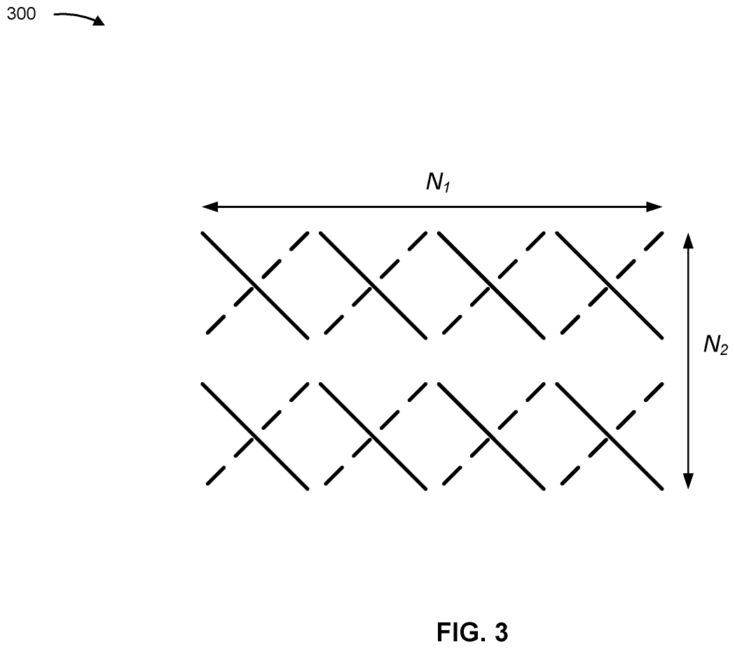

FIG. 3 is a diagram illustrating an example 300 of an LTE/NR Type-I single-panel codebook design, in accordance with the present disclosure.

In an LTE/NR Type-I single-panel codebook, for a two-dimensional antenna array, precoding vectors generated by a Kronecker product of horizontal and vertical discrete Fourier transform (DFT) vectors may be defined. N₁O₁ DFT vectors may be associated with a horizontal domain and N₂O₂ vectors may be associated with a vertical domain, where N₁ and N₂ represent a numbers of antenna ports in the horizontal and vertical domains, respectively, and O₁ and O₂ represent oversampling factors in the horizontal and vertical domains, respectively.

In a codebook structure, W=W₁W₂, where W indicates a precoding matrix (or precoder). Further, W₁ may be associated with a beam group selection. For rank 1, closely spaced horizontal and vertical DFT vectors may be selected. For higher ranks (e.g., rank 2-4), orthogonal pairs of horizontal and vertical DFT vectors may be selected. Further, W₂ may be associated with a beam selection and co-phasing between different poles. In the case of NR, a rank 3-4 codebook for higher than 8 Tx antennas may adopt a double co-phasing structure.

As indicated above, FIG. 3 is provided as an example. Other examples may differ from what is described with regard to FIG. 3.

For a Type-I single-panel codebook, various codebook parameters may be defined. For 4 antenna ports {3000, 3001, 3002, 3003}, 8 antenna ports {3000, 3001, . . . , 3007}, 12 antenna ports {3000, 3001, . . . , 3011}, 16 antenna ports {3000, 3001, . . . , 3015}, 24 antenna ports {3000, 3001, . . . , 3023}, and 32 antenna ports {3000, 3001, . . . , 3031}, and for a UE configured with higher layer parameter codebookType set to ‘typeI-SinglePanel’, except when a number of layers ν∈{2,3,4} (where ν is an associated rank indication (RI) value), each precoding matrix indicator (PMI) value may correspond to three codebook indices i_{1,1}, i_{1,2}, i₂. When the number of layers ν∈{2,3,4}, each PMI value may correspond to four codebook indices i_{1,1}, i_{1,2}, i_{1,3}, i₂. A composite codebook index i₁ may be defined by:

$${i}_{1} = \{ \begin{matrix}[ \begin{matrix}{i}_{1 , 1} & {i}_{1 , 2} ]\end{matrix} & υ ∉ \{ 2 , 3 , 4 \} \\ [ \begin{matrix}{i}_{1 , 1} & {i}_{1 , 2} & {i}_{1 , 3} ]\end{matrix} & υ ∈ \{ 2 , 3 , 4 \}\end{matrix} .$$

Further, the quantities φₙ, θₚ, uₘ, ν_{l,m}, and \tilde{ν}_{l,m} are given by:

$$\begin{matrix}{φ}_{n} = {e}^{j π n / 2} \\ {θ}_{p} = {e}^{j π p / 4} \\ {u}_{m} = \{ \begin{matrix}[ 1 {e}^{j \frac{2 π m}{{O}_{2} {N}_{2}}} … {e}^{j \frac{2 π m ( {N}_{2} - 1 )}{{O}_{2} {N}_{2}}} ] & {N}_{2} > 1 \\ 1 & {N}_{2} = 1\end{matrix} \\ {v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T} \\ {\tilde{v}}_{l , m} = {[ {u}_{m} {e}^{j \frac{4 π l}{{O}_{1} {N}_{1}}} {u}_{m} … {e}^{j \frac{4 π l ( {N}_{1} / 2 - 1 )}{{O}_{1} {N}_{1}}} {u}_{m} ]}^{T}\end{matrix}$$

The values of N₁ and N₂ may be configured with a higher layer parameter n1-n2, respectively. Supported configurations of (N₁, N₂) may be associated with a given number of channel state information reference signal (CSI-RS) ports and corresponding values of (O₁, O₂). A number of CSI-RS ports, P_{CSI-RS}, may be 2N₁N₂. Further, the UE may use i_{1,2}=0 and may not report i_{1,2} when a value of N₂ is equal to 1.

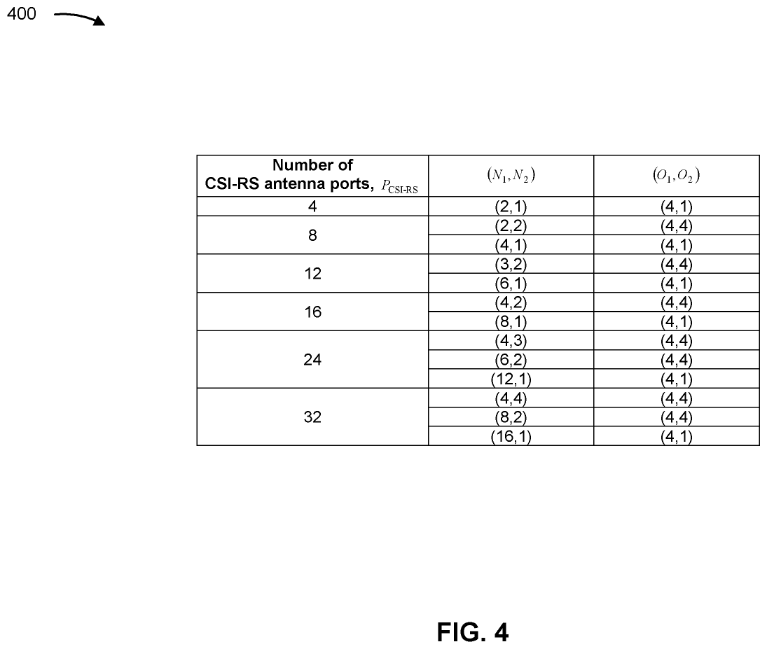

FIG. 4 is a diagram illustrating an example 400 of supported configurations of (N₁, N₂) and (O₁, O₂), in accordance with the present disclosure. As shown in FIG. 4, depending on a number of CSI-RS antenna ports (P_{CSI-RS}), corresponding values of (N₁, N₂) and (O₁, O₂) may be configured. The number of CSI-RS antenna ports may be equal to 4, 8, 12, 16, 24, or 32. As indicated above, FIG. 4 is provided as an example. Other examples may differ from what is described with regard to FIG. 4.

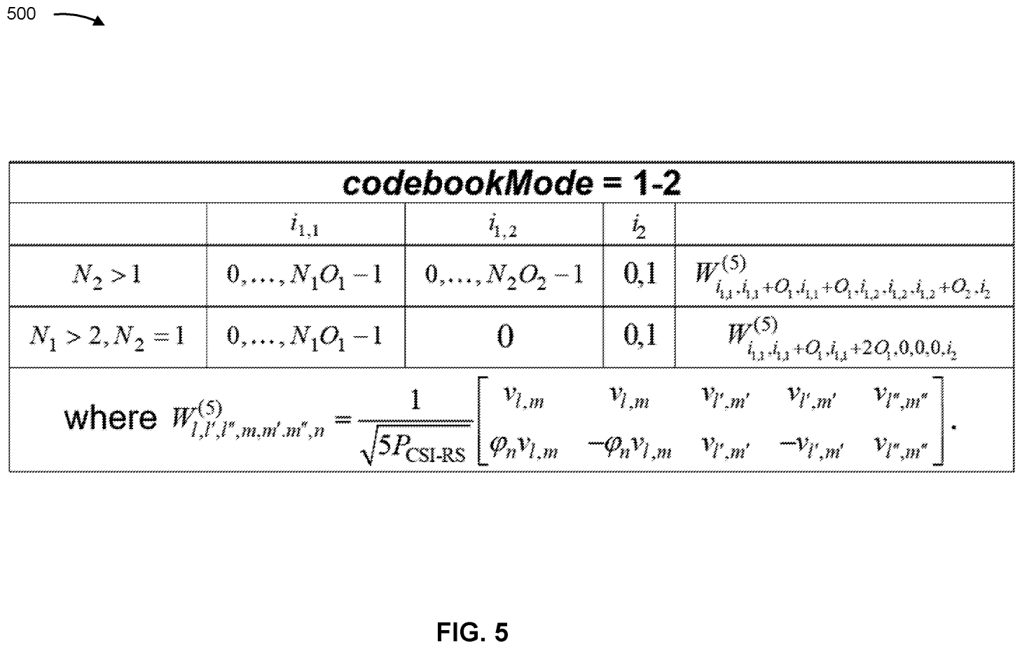

FIG. 5 is a diagram illustrating an example 500 of a Type-I single-panel codebook, in accordance with the present disclosure. As shown in FIG. 5, a Type-I single-panel codebook may be defined for a 5-layer CSI reporting using antenna ports 3000 to 2999+P_{CSI-RS}. As indicated above, FIG. 5 is provided as an example. Other examples may differ from what is described with regard to FIG. 5.

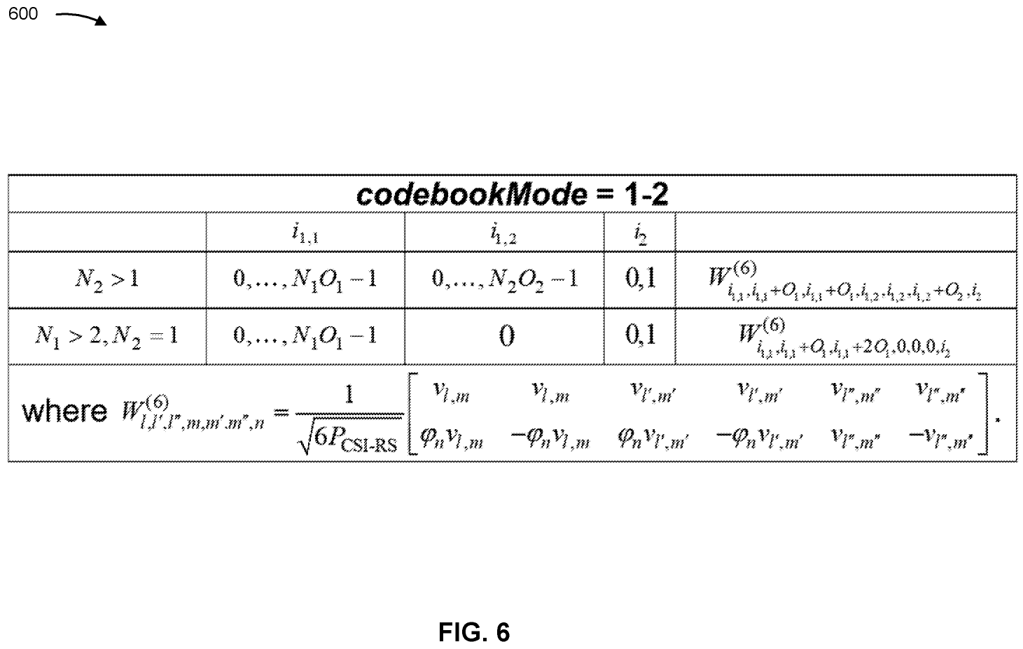

FIG. 6 is a diagram illustrating an example 600 of a Type-I single-panel codebook, in accordance with the present disclosure. As shown in FIG. 6, a Type-I single-panel codebook may be defined for a 6-layer CSI reporting using antenna ports 3000 to 2999+P_{CSI-RS}. As indicated above, FIG. 6 is provided as an example. Other examples may differ from what is described with regard to FIG. 6.

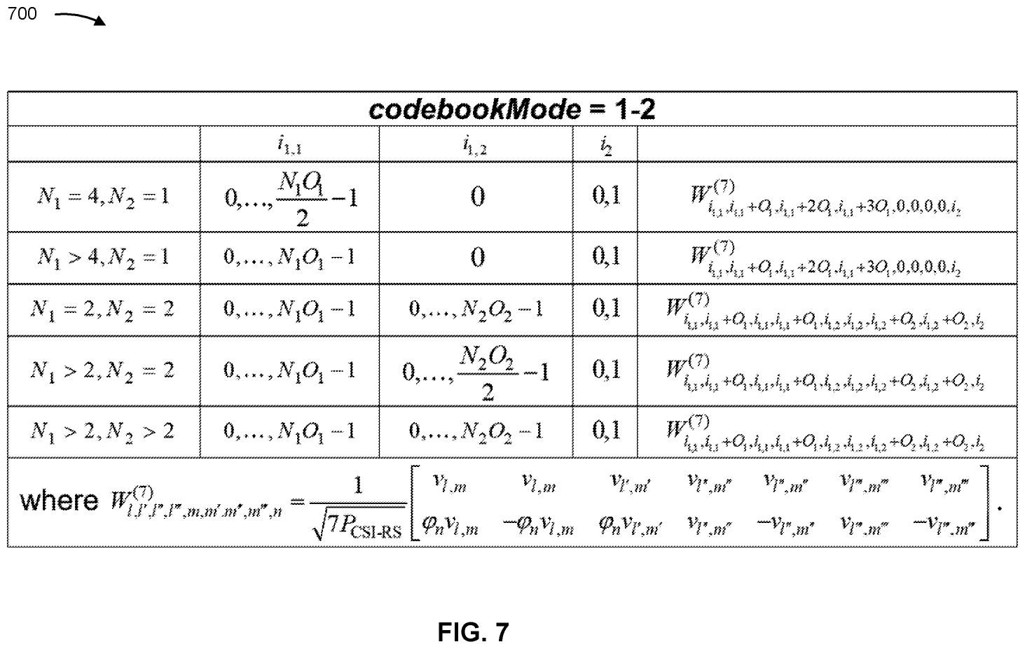

FIG. 7 is a diagram illustrating an example 700 of a Type-I single-panel codebook, in accordance with the present disclosure. As shown in FIG. 7, a Type-I single-panel codebook may be defined for a 7-layer CSI reporting using antenna ports 3000 to 2999+P_{CSI-RS}. As indicated above, FIG. 7 is provided as an example. Other examples may differ from what is described with regard to FIG. 7.

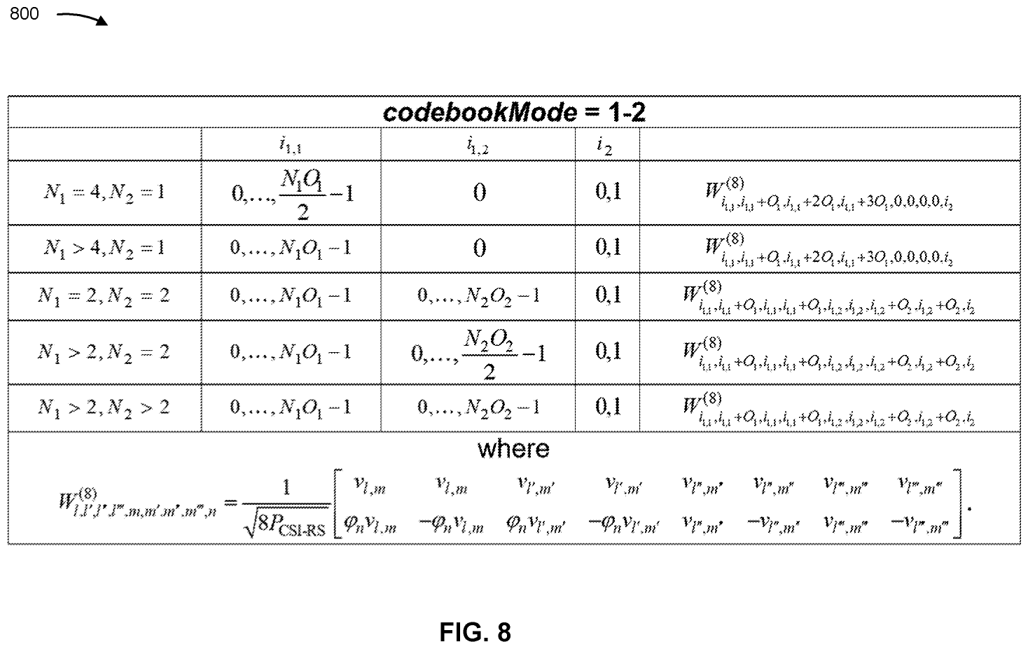

FIG. 8 is a diagram illustrating an example 800 of a Type-I single-panel codebook, in accordance with the present disclosure. As shown in FIG. 8, a Type-I single-panel codebook may be defined for an 8-layer CSI reporting using antenna ports 3000 to 2999+P_{CSI-RS}. As indicated above, FIG. 8 is provided as an example. Other examples may differ from what is described with regard to FIG. 8.

For a Type I single-panel codebook, a PMI may be composed of i₁ and i₂ information, where it may be associated with a wideband beam group selection and i₂ may be associated with a sub-band beam selection and co-phasing between different antenna polarizations.

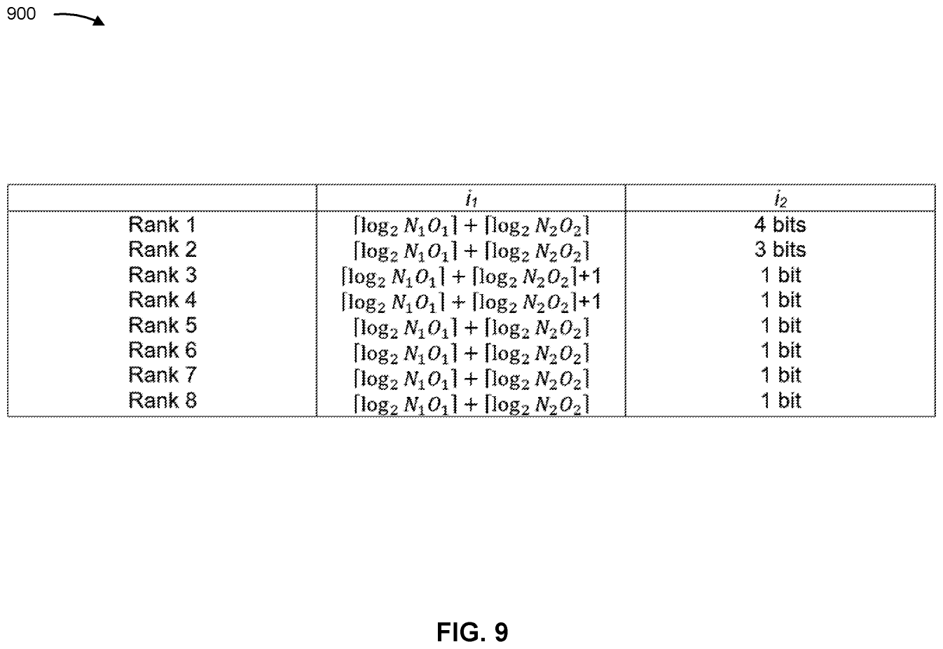

FIG. 9 is a diagram illustrating an example 900 of a maximum number of bits for feedback, in accordance with the present disclosure. As shown in FIG. 9, a maximum number of bits may be defined for i₁ and i₂ feedback. The maximum number of bits for the it and i₂ feedback may be for each rank, such as rank 1-8. As indicated above, FIG. 9 is provided as an example. Other examples may differ from what is described with regard to FIG. 9.

For a downlink Type-I single-panel codebook type and a downlink Type-I multi-panel codebook type, an improved design may be needed with respect to rank 5-8. The improved design with respect to rank 5-8 may be due to an existing transmission rank that is less than or equal to a minimum number of Tx antennas and/or a minimum number of Rx antennas. In past systems, devices have had less than or equal to four Rx antennas, so a rank 5-8 performance was less important. In newer systems, a larger number of Rx antennas are being considered for mobile devices and larger sized devices, such as personal computers and customer premises equipment that utilize 5G NR, so a rank 5-8 MIMO performance in NR is more important as compared to the past systems.

In various aspects of techniques and apparatuses described herein, a UE may determine one or more parameters for a rank 5-8 Type-I codebook. For example, the UE may select the one or more parameters for the rank 5-8 Type-I codebook, and/or the UE may receive, from the base station, an indication of the one or more parameters for the rank 5-8 Type-I codebook. The UE may perform, to the base station, a rank 5-8 CSI reporting based at least in part on the rank 5-8 Type-I codebook that includes the one or more parameters. As a result, the UE may perform the rank 5-8 CSI reporting using the rank 5-8 Type-I codebook resulting in an improved performance (e.g., an increased throughput), as opposed to using a rank 1-4 Type-I codebook or a previous rank 5-8 Type-I codebook without the one or more parameters selected by the UE and/or configured by the base station.

FIG. 10 is a diagram illustrating an example 1000 associated with CSI reporting using codebooks, in accordance with the present disclosure. As shown in FIG. 10, example 1000 includes communication between a UE (e.g., UE 120) and a base station (e.g., base station 110). In some aspects, the UE and the base station may be included in a wireless network, such as wireless network 100.

As shown by reference number 1002, the UE may determine one or more parameters for a rank 5-8 Type-I codebook. The UE may select the one or more parameters for the rank 5-8 Type-I codebook, without input from a base station. Additionally, or alternatively, the UE may receive, from the base station, an indication of the one or more parameters for the rank 5-8 Type-I codebook. In some aspects, the rank 5-8 Type-I codebook may be one of a rank 5 Type-I codebook, a rank 6 Type-I codebook, a rank 7 Type-I codebook, or a rank 8 Type-I codebook.

In some aspects, the rank 5-8 Type-I codebook may be a single-panel rank 5-8 Type-I codebook. Alternatively, the rank 5-8 Type-I codebook may be a multi-panel rank 5-8 Type-I codebook.

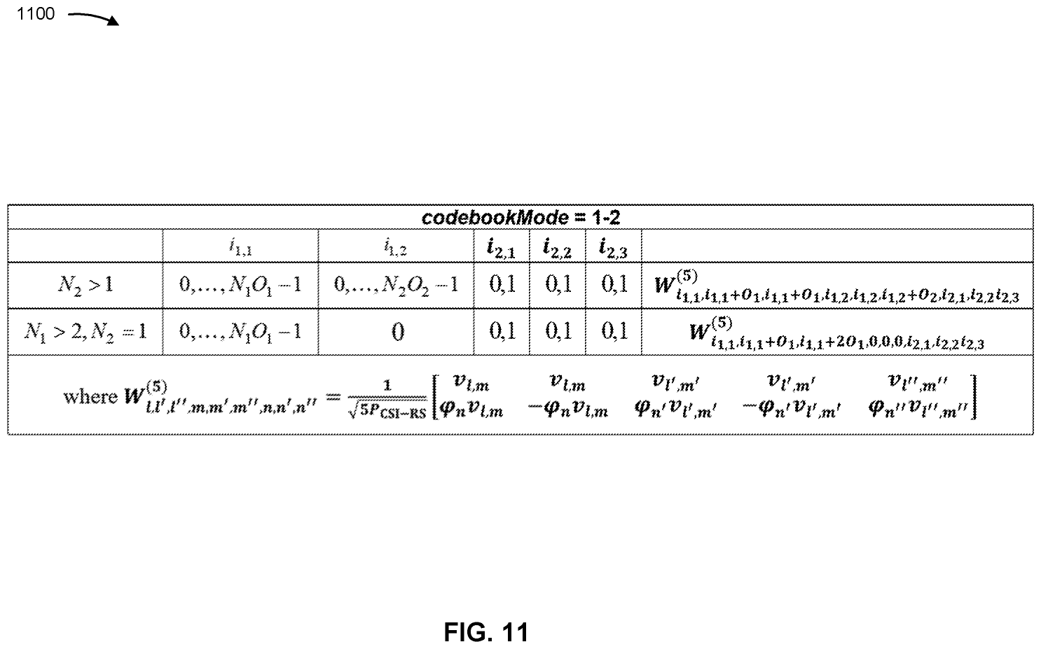

In some aspects, the one or more parameters for the rank 5-8 Type-I codebook may include beam-specific co-phasing factors (φₙ). A co-phasing factor may be defined for each beam indicated in the rank 5-8 Type-I codebook. The beam-specific co-phasing factors are further shown in FIGS. 11-14.

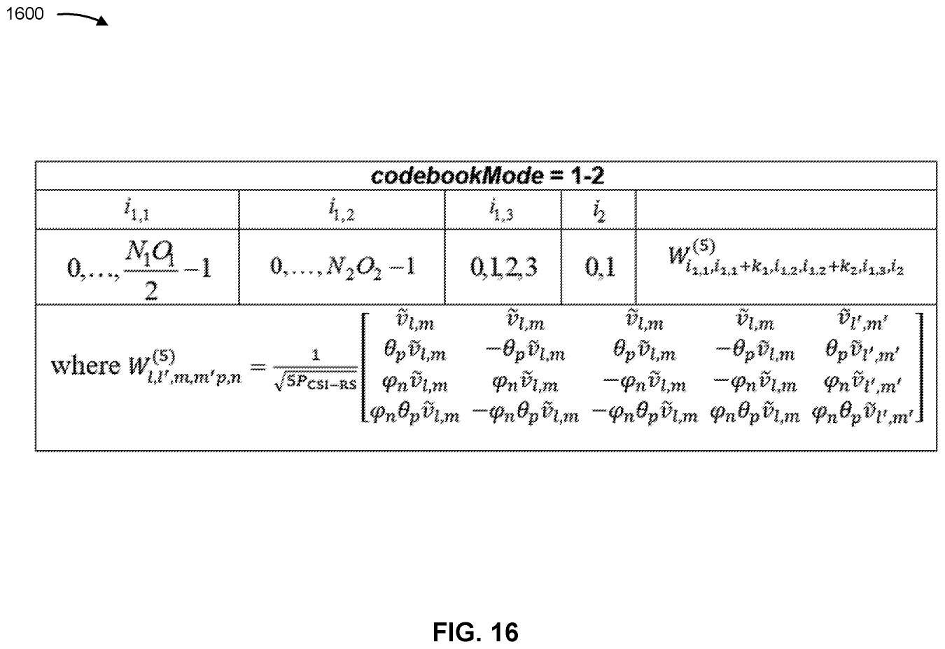

In some aspects, the one or more parameters for the rank 5-8 Type-I codebook may include: a first co-phasing factor (or structure) (φₙ) applied for a cross-polarization associated with the rank 5-8 Type-I codebook, and a second co-phasing factor (or structure) (θₚ) applied for different antenna groups formed from a plurality of transmit antennas associated with the UE. The first co-phasing factor and the second co-phasing factor are further shown in FIGS. 16-19.

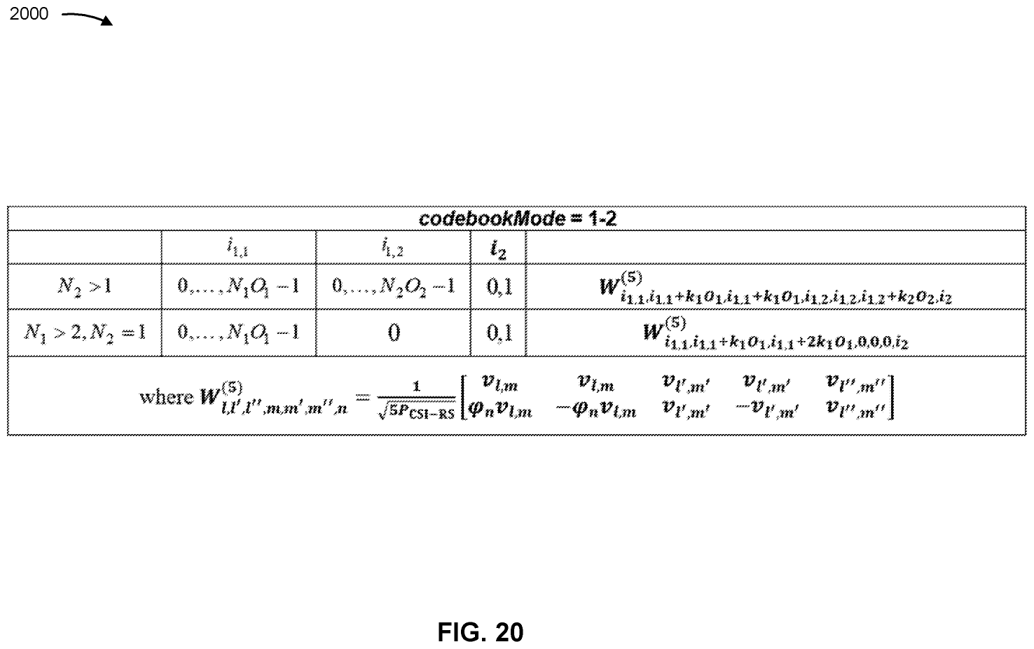

In some aspects, the one or more parameters for the rank 5-8 Type-I codebook may include a first integer value (k₁) and a second integer value (k₂) to provide an angular distance between different beams, as indicated in the rank 5-8 Type-I codebook, that satisfies a threshold. The first integer value and the second integer value are further shown in FIGS. 20-23.

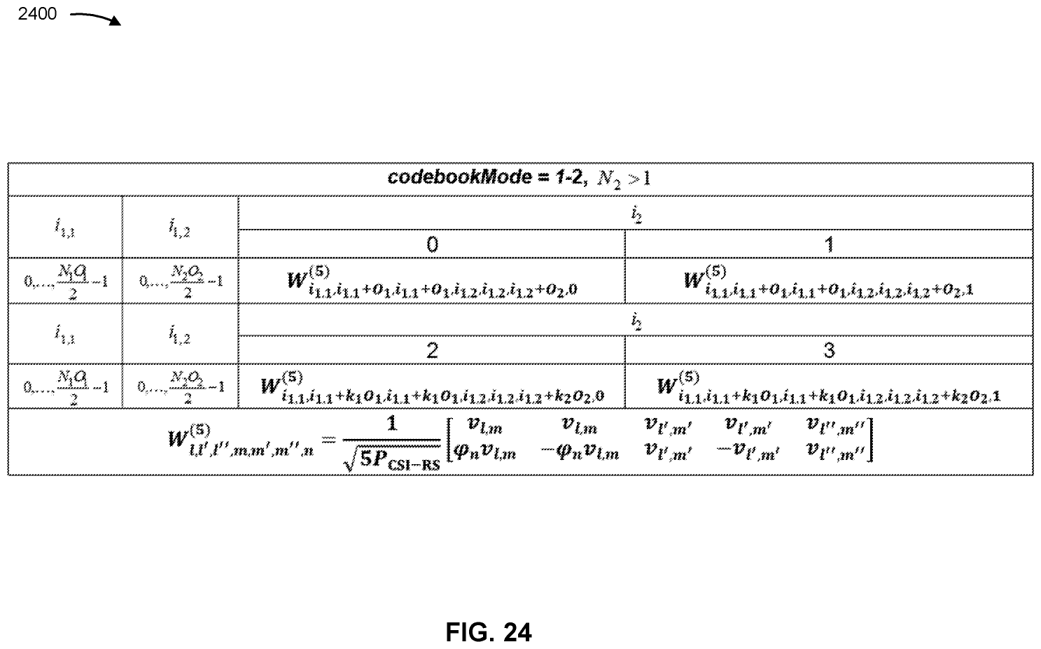

In some aspects, the one or more parameters for the rank 5-8 Type-I codebook may include a first codebook index (i_{1,1}), a second codebook index (i_{1,2}), and a third codebook index (i₂). The first codebook index and the second codebook index may be associated with a wideband channel and indicate a group of beams. The third codebook index may be associated with a sub-band channel and indicates a beam selection from the group of beams. The third codebook index may be based at least in part on a quantity of antenna elements in a vertical domain. The first codebook index, the second codebook index, and the third codebook index are further shown in FIGS. 24-31.

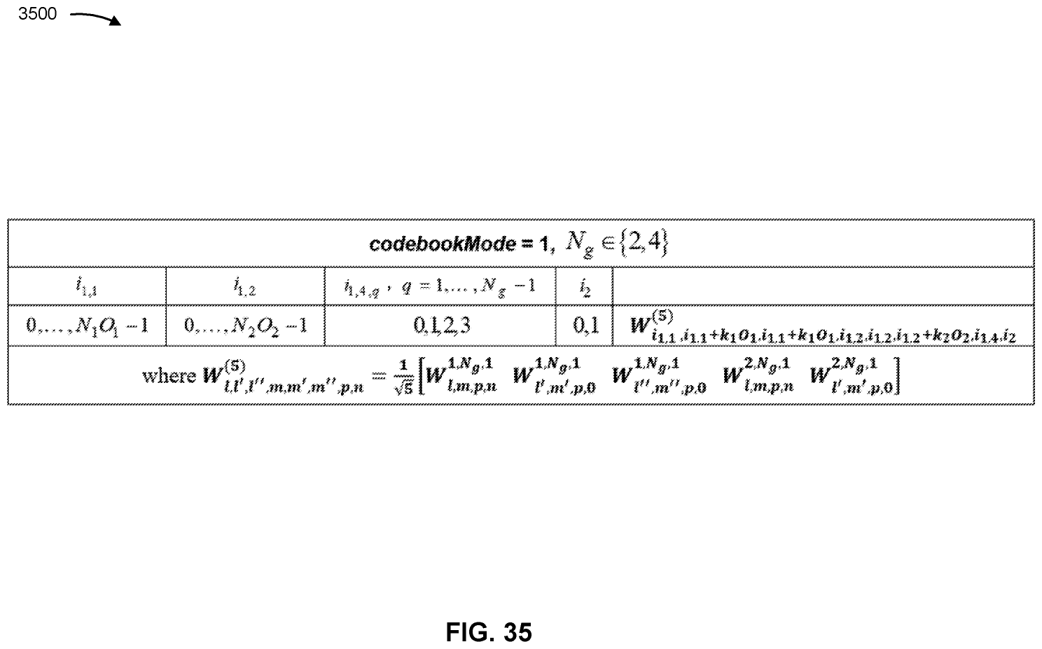

In some aspects, the multi-panel rank 5-8 Type-I codebook may be based at least in part on a concatenation of two or more single-panel rank 5-8 Type-I precoders with panel co-phasing factors. In some aspects, the multi-panel rank 5-8 Type-I codebook may be associated with a first mode (Mode 1), where a same precoder may be applied to different antenna panels based at least in part on the first mode. In some aspects, the multi-panel rank 5-8 Type-I codebook may be associated with a second mode (Mode 2). A first precoder may be applied to a first antenna panel and a second precoder may be applied to a second antenna panel based at least in part on the second mode. The first precoder and the second precoder may apply a same beam for each polarization associated with the first antenna panel and the second antenna panel. The first precoder may apply first co-phasing factors for cross polarizations associated with the first antenna panel and the second precoder may apply second co-phasing factors for cross polarizations associated with the second antenna panel. The multi-panel rank 5-8 Type-I codebook is further shown in FIGS. 35-42.

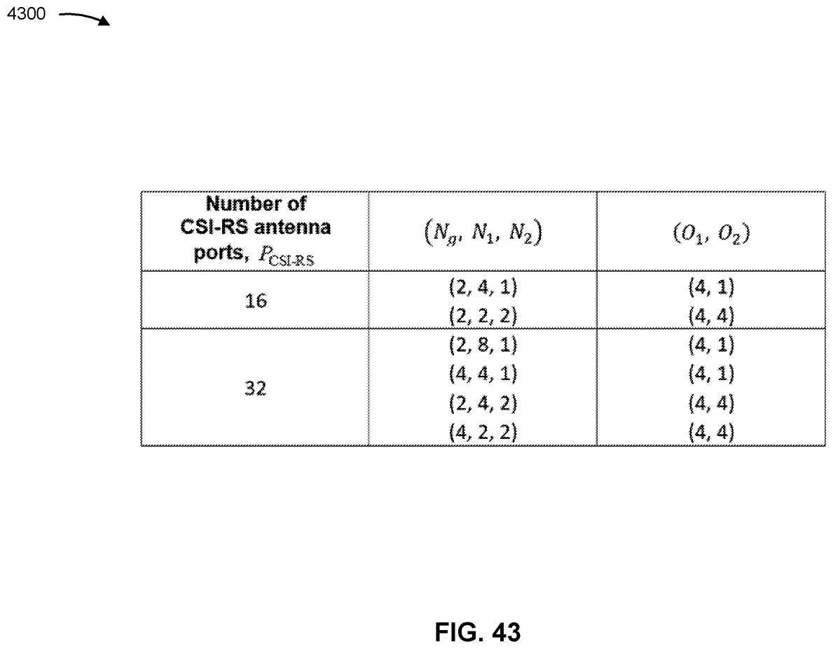

In some aspects, antenna configurations supported by the multi-panel rank 5-8 Type-I codebook may include a first set of antenna configurations associated with 16 antenna ports and a second set of antenna configurations associated with 32 antenna ports. The antenna configurations supported by the multi-panel rank 5-8 Type-I codebook may exclude antenna configurations associated with 8 antenna ports. The antenna configurations supported by the multi-panel rank 5-8 Type-I codebook are further shown in FIG. 43.

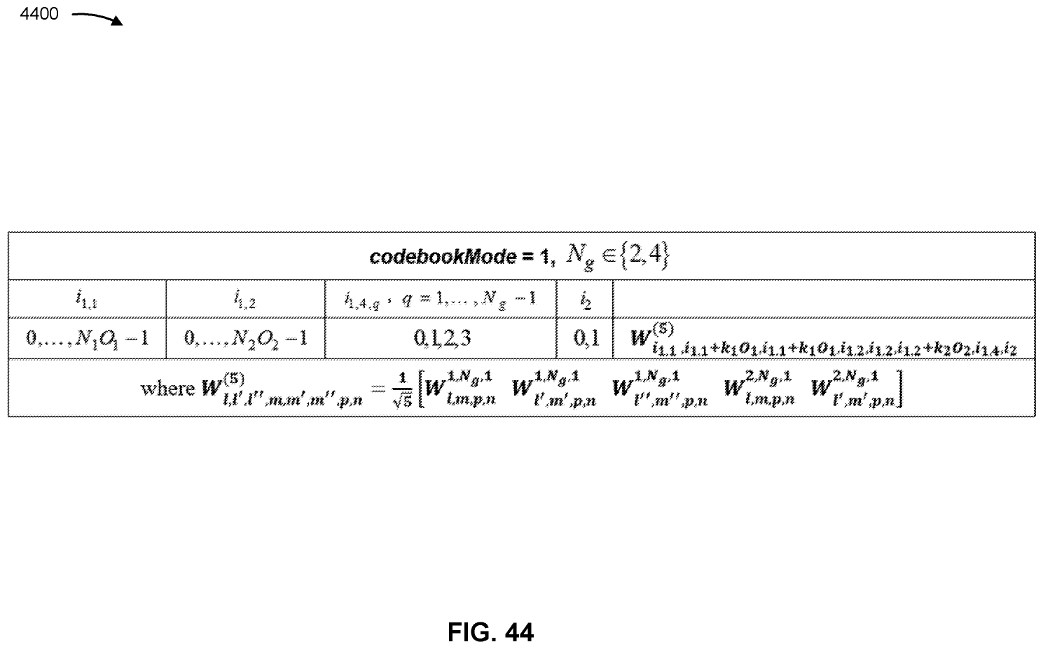

In some aspects, the multi-panel rank 5-8 Type-I codebook may include a co-phasing factor for each beam indicated in the multi-panel rank 5-8 Type-I codebook. The co-phasing factor may be indicated for each beam in the multi-panel rank 5-8 Type-I codebook as an alternative approach and is further shown in FIGS. 44-51.

As shown by reference number 1004, the UE may perform, to the base station, a rank 5-8 CSI reporting based at least in part on the rank 5-8 Type-I codebook that includes the one or more parameters. The UE may perform the rank 5-8 CSI reporting based at least in part on the beam-specific co-phasing factors included in the rank 5-8 Type-I codebook. The UE may perform the rank 5-8 CSI reporting based at least in part on the first co-phasing factor and the second co-phasing factor included in the rank 5-8 Type-I codebook. The UE may perform the rank 5-8 CSI reporting based at least in part on the first integer value and the second integer value included in the rank 5-8 Type-I codebook. The UE may perform the rank 5-8 CSI reporting based at least in part on the first codebook index, the second codebook index, and the third codebook index included in the rank 5-8 Type-I codebook. The UE may perform the rank 5-8 CSI reporting using the single-panel rank 5-8 Type-I codebook or the multi-panel rank 5-8 Type-I codebook.

As indicated above, FIG. 10 is provided as an example. Other examples may differ from what is described with regard to FIG. 10.

In some aspects, with respect to a Type-I single-panel rank 5-8 codebook enhancement, a rich scattered MIMO channel may provide different phase changes for different beam paths for high-rank transmissions. A maximum number of bits for a PMI may correspond to a rank being equal to one (as shown in FIG. 9). When considering dynamic rank adaptation, PMI feedback may be prepared for the case of rank 1, such that i₂ feedback may be prepared using spare bits for the case of rank 5-8. Further, considering such rich scattering and the spare bits used for the i₂ feedback, a rank 5-8 codebook may be enhanced by adopting beam-specific co-phasing factors (φₙ), which may be realized with additional bits for the i₂ feedback.

In some aspects, a rank 5-6 codebook may be defined with beam-specific co-phasing factors, where i₂=[i_{2,1} i_{2,2} i_{2,3}]. In some aspects, to reduce an i₂ bit-width, one or two of i_{2,1}, i_{2,2} and i_{2,3} may be restricted to be 0. Alternatively, restrictions of i_{2,1}=i_{2,2} or i_{2,2}=i_{2,3} may be defined. In some aspects, a rank 7-8 codebook may be defined with beam-specific co-phasing factors, where i₂=[i_{2,1} i_{2,2} i_{2,3} i_{2,4}]. In some aspects, to reduce an i₂ bit-width, one or two or three of i_{2,1}, i_{2,2}, i_{2,3} and i_{2,4} may be restricted to be 0. Alternatively, restrictions of i_{2,1}=i_{2,2} and i_{2,3}=i_{2,4} may be defined.

FIG. 11 is a diagram illustrating an example 1100 associated with a codebook for CSI reporting with beam-specific co-phasing factors, in accordance with the present disclosure. As shown in FIG. 11, a codebook may be defined for 5-layer CSI reporting with beam-specific co-phasing factors. A specific co-phasing factor may be defined for each beam indicated in the codebook (e.g., 5 beams for rank 5). As indicated above, FIG. 11 is provided as an example. Other examples may differ from what is described with regard to FIG. 11.

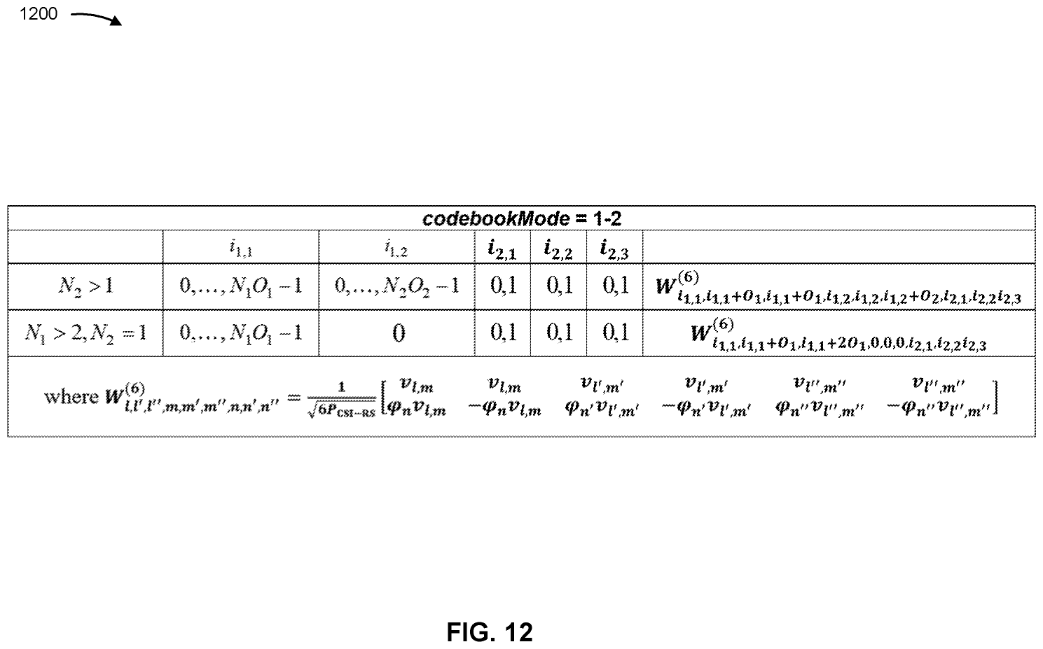

FIG. 12 is a diagram illustrating an example 1200 associated with a codebook for CSI reporting with beam-specific co-phasing factors, in accordance with the present disclosure. As shown in FIG. 12, a codebook may be defined for 6-layer CSI reporting with beam-specific co-phasing factors. A specific co-phasing factor may be defined for each beam indicated in the codebook (e.g., 6 beams for rank 6). As indicated above, FIG. 12 is provided as an example. Other examples may differ from what is described with regard to FIG. 12.

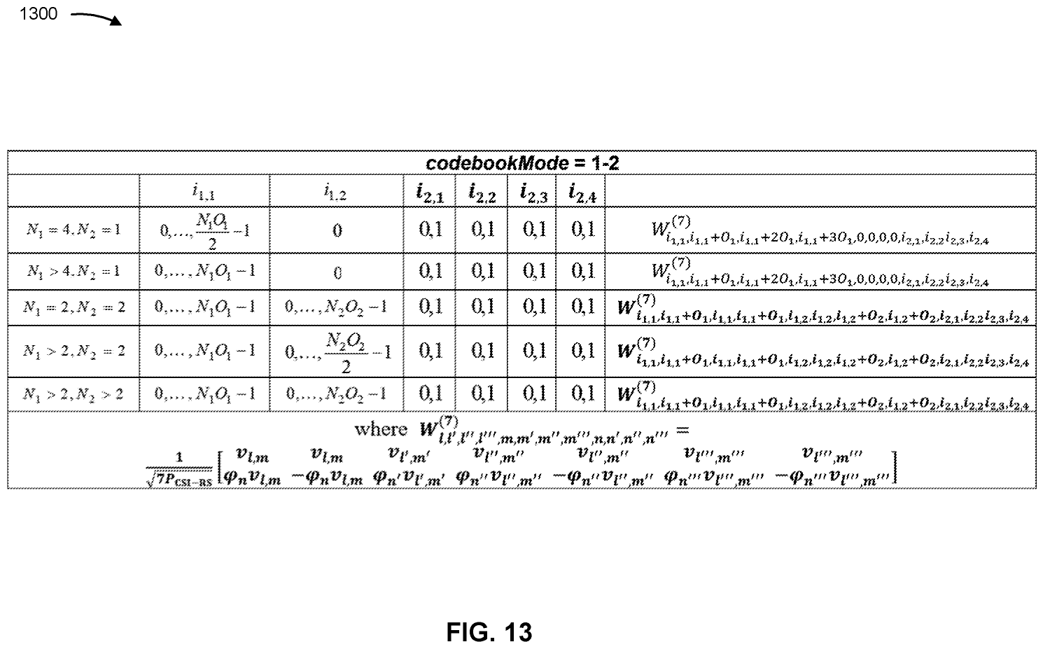

FIG. 13 is a diagram illustrating an example 1300 associated with a codebook for CSI reporting with beam-specific co-phasing factors, in accordance with the present disclosure. As shown in FIG. 13, a codebook may be defined for 7-layer CSI reporting with beam-specific co-phasing factors. A specific co-phasing factor may be defined for each beam indicated in the codebook (e.g., 7 beams for rank 7). As indicated above, FIG. 13 is provided as an example. Other examples may differ from what is described with regard to FIG. 13.

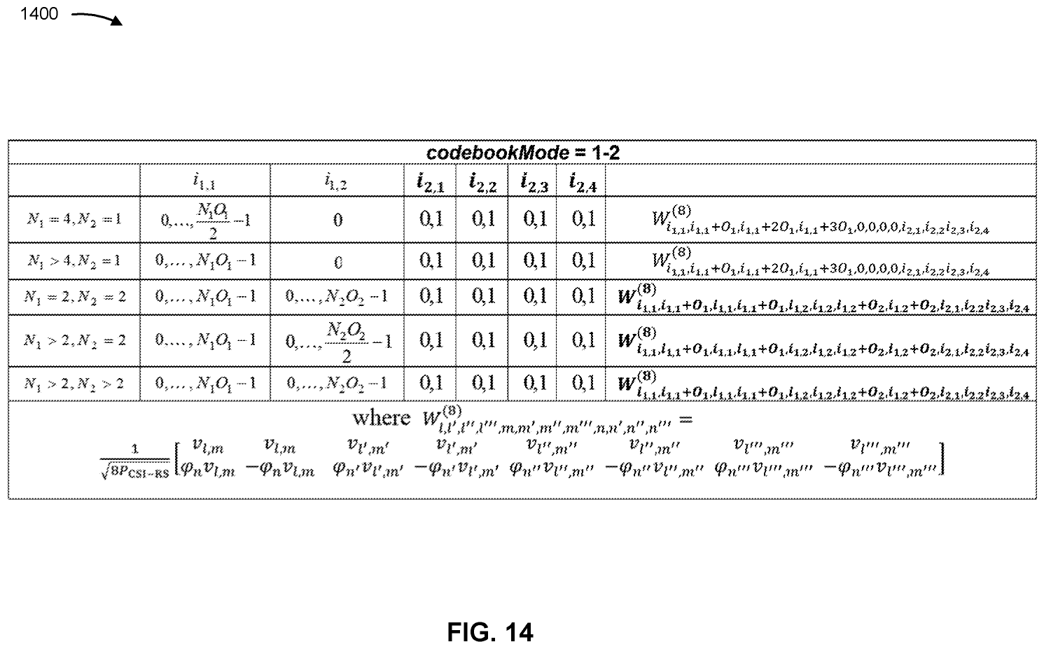

FIG. 14 is a diagram illustrating an example 1400 associated with a codebook for CSI reporting with beam-specific co-phasing factors, in accordance with the present disclosure. As shown in FIG. 14, a codebook may be defined for 8-layer CSI reporting with beam-specific co-phasing factors. A specific co-phasing factor may be defined for each beam indicated in the codebook (e.g., 8 beams for rank 8). As indicated above, FIG. 14 is provided as an example. Other examples may differ from what is described with regard to FIG. 14.

In some aspects, when a number of Tx antennas is relatively large, a likelihood of obtaining a higher rank transmission may be increased. When the number of Tx antennas is relatively large, antenna ports may be partitioned into multiple antenna groups. When the relatively large number of Tx antennas are partitioned into the multiple antenna groups, additional phase alignment between different antenna groups of the multiple antenna groups may provide an improved beamforming gain.

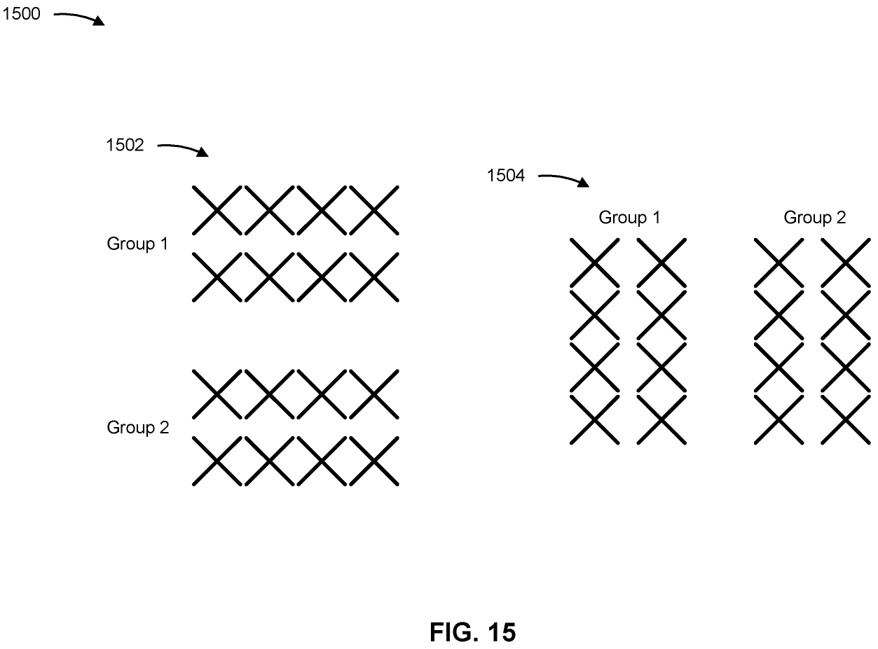

FIG. 15 is a diagram illustrating an example 1500 associated with multiple antenna groups, in accordance with the present disclosure.

As shown by reference number 1502, a number of Tx antennas may be split into a first antenna group and a second antenna group. The first antenna group may include an array of 8 total Tx antennas, with four Tx antennas in a horizontal domain and two Tx antennas in a vertical domain. Similarly, the second antenna group may include an array of 8 total Tx antennas, with four Tx antennas in a horizontal domain and two Tx antennas in a vertical domain.

As shown by reference number 1504, a number of Tx antennas may be split into a first antenna group and a second antenna group. The first antenna group may include an array of 8 total Tx antennas, with two Tx antennas in a horizontal domain and four Tx antennas in a vertical domain. Similarly, the second antenna group may include an array of 8 total Tx antennas, with two Tx antennas in a horizontal domain and four Tx antennas in a vertical domain.

As indicated above, FIG. 15 is provided as an example. Other examples may differ from what is described with regard to FIG. 15.

In some aspects, when considering the additional phase alignment for different antenna groups, a rank 5-8 codebook may be enhanced by adopting a double co-phasing structure. The double co-phasing structure may apply two co-phasing factors, where a first co-phasing structure (φₙ) may be applied for a cross polarization, and a second co-phasing structure (θₚ) may be applied for different antenna groups.

In some aspects, rank 5-8 codebooks with a double co-phasing structure may be defined, where k₁ and k₂ may be set as an integer multiple of O₁ and O₂, respectively, to make a precoding matrix have orthogonal columns. Thus, (k₁, k₂) may be fixed from

$$\{ ( {O}_{1} , 0 ) , ( 0 , {O}_{2} ) , ( {O}_{1} , {O}_{2} ) , ( 2 {O}_{1} , {O}_{2} ) , ( {O}_{1} , 2 {O}_{2} ) … , ( \frac{{N}_{1}}{4} {O}_{1} , \frac{{N}_{2}}{2} {O}_{2} ) \} ,$$

which may be configured by a base station or selected by a UE.

FIG. 16 is a diagram illustrating an example 1600 associated with a codebook for CSI reporting with a double co-phasing structure, in accordance with the present disclosure. As shown in FIG. 16, a codebook may be defined for 5-layer CSI reporting with a double co-phasing structure. For rank 5, a first co-phasing structure (φₙ) may be applied for a cross polarization and a second co-phasing structure (θₚ) may be applied for different antenna groups. As indicated above, FIG. 16 is provided as an example. Other examples may differ from what is described with regard to FIG. 16.

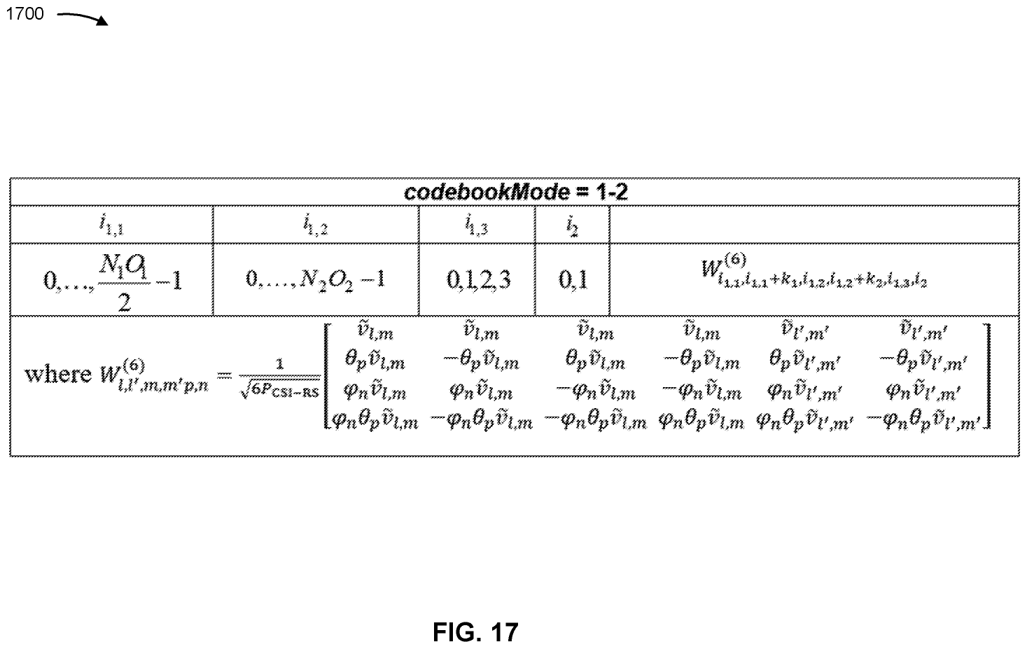

FIG. 17 is a diagram illustrating an example 1700 associated with a codebook for CSI reporting with a double co-phasing structure, in accordance with the present disclosure. As shown in FIG. 17, a codebook may be defined for 6-layer CSI reporting with a double co-phasing structure. For rank 6, a first co-phasing structure may be applied for a cross polarization and a second co-phasing structure may be applied for different antenna groups. As indicated above, FIG. 17 is provided as an example. Other examples may differ from what is described with regard to FIG. 17.

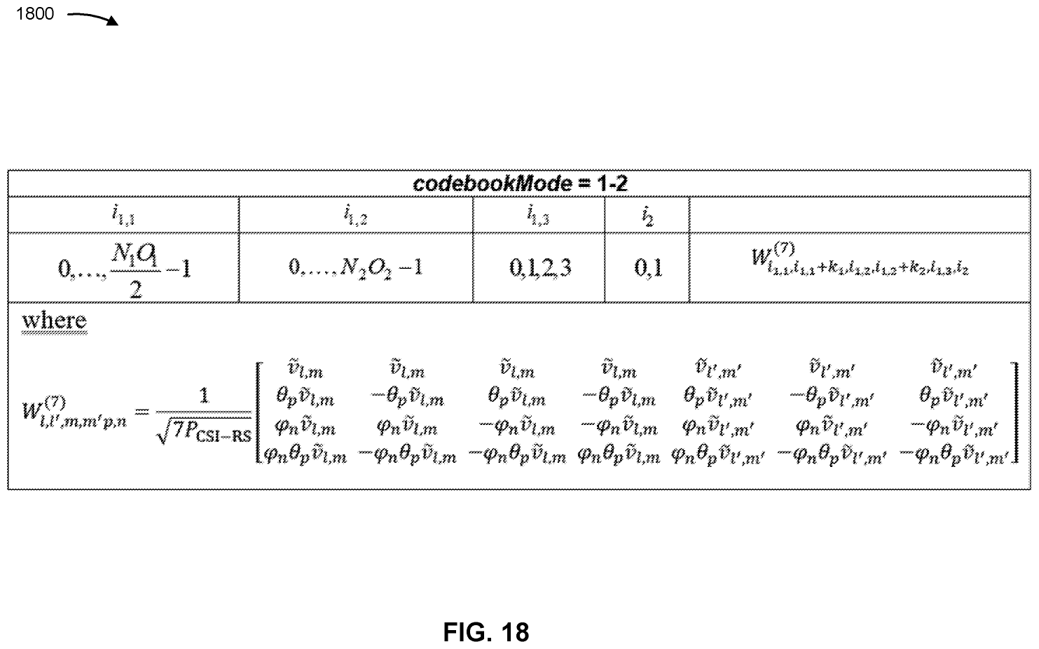

FIG. 18 is a diagram illustrating an example 1800 associated with a codebook for CSI reporting with a double co-phasing structure, in accordance with the present disclosure. As shown in FIG. 18, a codebook may be defined for 7-layer CSI reporting with a double co-phasing structure. For rank 7, a first co-phasing structure may be applied for a cross polarization and a second co-phasing structure may be applied for different antenna groups. As indicated above, FIG. 18 is provided as an example. Other examples may differ from what is described with regard to FIG. 18.

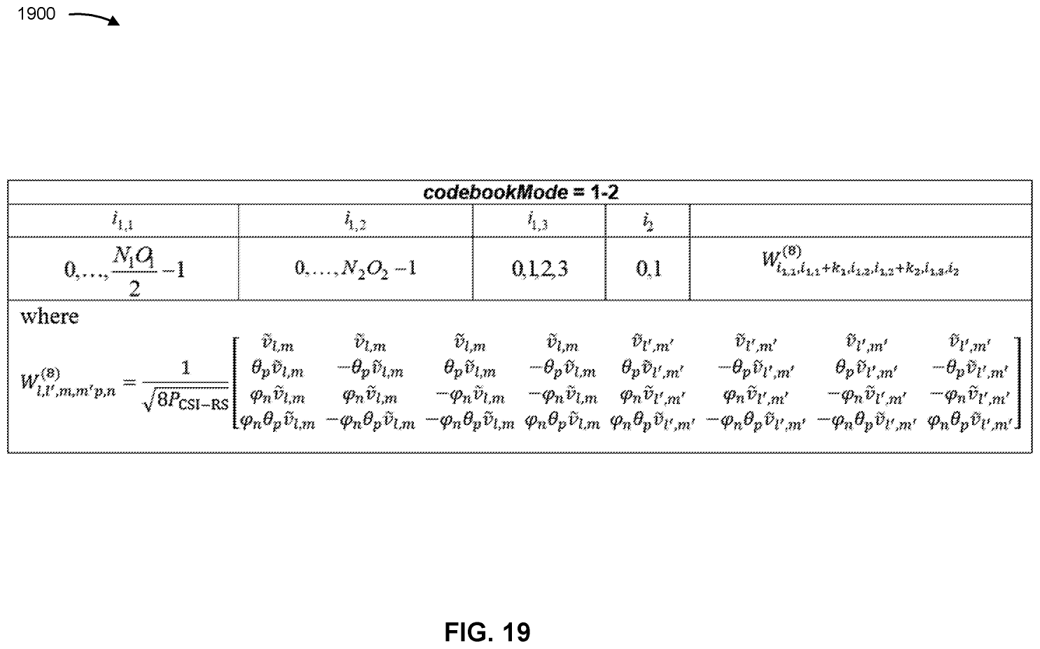

FIG. 19 is a diagram illustrating an example 1900 associated with a codebook for CSI reporting with a double co-phasing structure, in accordance with the present disclosure. As shown in FIG. 19, a codebook may be defined for 8-layer CSI reporting with a double co-phasing structure. For rank 8, a first co-phasing structure may be applied for a cross polarization and a second co-phasing structure may be applied for different antenna groups. As indicated above, FIG. 19 is provided as an example. Other examples may differ from what is described with regard to FIG. 19.

In some aspects, high-rank transmissions may typically occur in rich scattered MIMO channels, which may have multiple different beam paths with a relatively large angular spread. From a codebook perspective, the rich scattered MIMO channels may be translated into a precoding matrix having orthogonal columns with a relatively large angular distance between each other. An angular distance between different columns may be related to a difference of DFT vector indices, and an orthogonality of the precoding matrix may be guaranteed when the difference of the DFT vector indices is a multiple of O₁ in a horizontal domain and a multiple of O₂ in a vertical domain.

In some aspects, precoding matrices may be composed of DFT vector indices i₁₁ and i₁₁+k₁O₁ for the horizontal domain and DFT vector indices i₁₂, i₁₂+k₂O₂ for the vertical domain, where k₁>1 or k₂>1, may result in a codebook that is suitable for the rich scattered MIMO channels. For example, N₁=N₂=4 and O₁=O₂=4 may result in 16 horizontal beam indices and 16 vertical beam indices. In both the horizontal and vertical domains, index 0 and index 8 may have a largest angular distance. As a result, k₁=k₂=2 may provide a favorable codebook performance. Further,

$${k}_{1} = max ( 1 , ⌊ \frac{{N}_{1}}{2} ⌋ ) and {k}_{2} = max ( 1 , ⌊ \frac{{N}_{2}}{2} ⌋ )$$

may provide a favorable angular property of the codebook. Here, a “favorable angular property” may indicate a relatively large angular distance between different beams for different layers.

In some aspects, rank 5-8 codebooks with favorable angular properties may be defined, where k₁ and k₂ may be an integer number larger than or equal to 1. Further, k₁ and k₂ may be fixed numbers, e.g.,

$${k}_{1} = max ( 1 , ⌊ \frac{{N}_{1}}{2} ⌋ ) and {k}_{2} = max ( 1 , ⌊ \frac{{N}_{2}}{2} ⌋ ) ,$$

which may be configured by a base station or selected by a UE. In some examples, in the codebook, k₁ and k₂ may provide a relatively large angular distance between different beams for different layers, which may improve a system performance for higher rank transmissions (e.g., rank 5-8 transmissions).

FIG. 20 is a diagram illustrating an example 2000 associated with a codebook for CSI reporting with a favorable angular property, in accordance with the present disclosure. As shown in FIG. 20, a codebook may be defined for 5-layer CSI reporting with a favorable angular property. For rank 5, the codebook may include k₁ and k₂, configured by a base station or selected by a UE, which may provide a relatively large angular distance between different beams associated with the 5 layers indicated in the codebook. As indicated above, FIG. 20 is provided as an example. Other examples may differ from what is described with regard to FIG. 20.

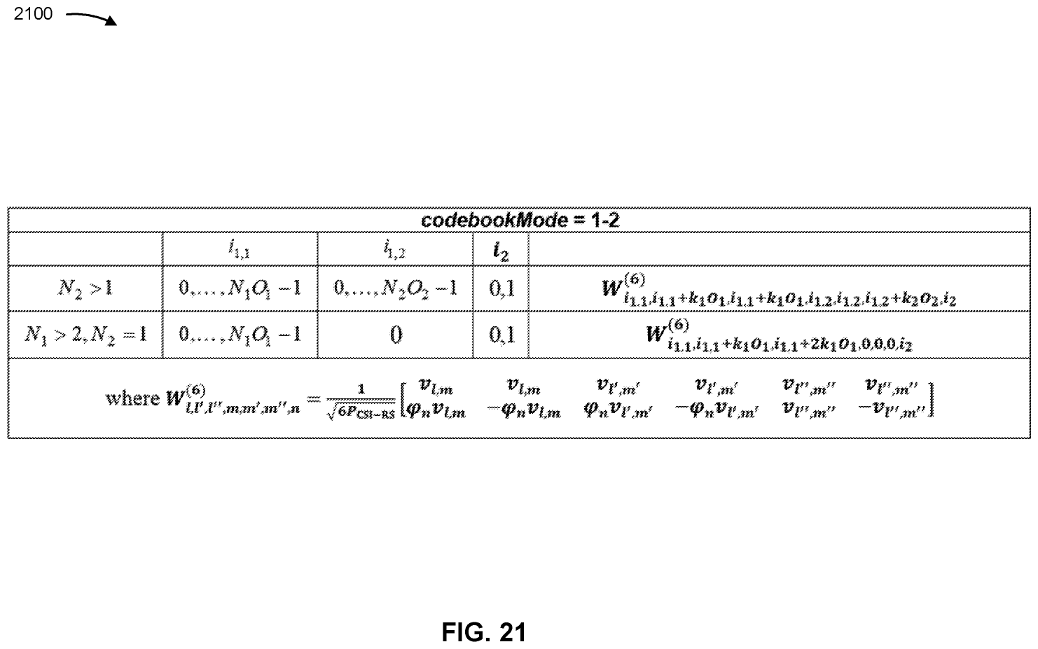

FIG. 21 is a diagram illustrating an example 2100 associated with a codebook for CSI reporting with a favorable angular property, in accordance with the present disclosure. As shown in FIG. 21, a codebook may be defined for 6-layer CSI reporting with a favorable angular property. For rank 6, the codebook may include k₁ and k₂, configured by a base station or selected by a UE, which may provide a relatively large angular distance between different beams associated with the 6 layers indicated in the codebook. As indicated above, FIG. 21 is provided as an example. Other examples may differ from what is described with regard to FIG. 21.

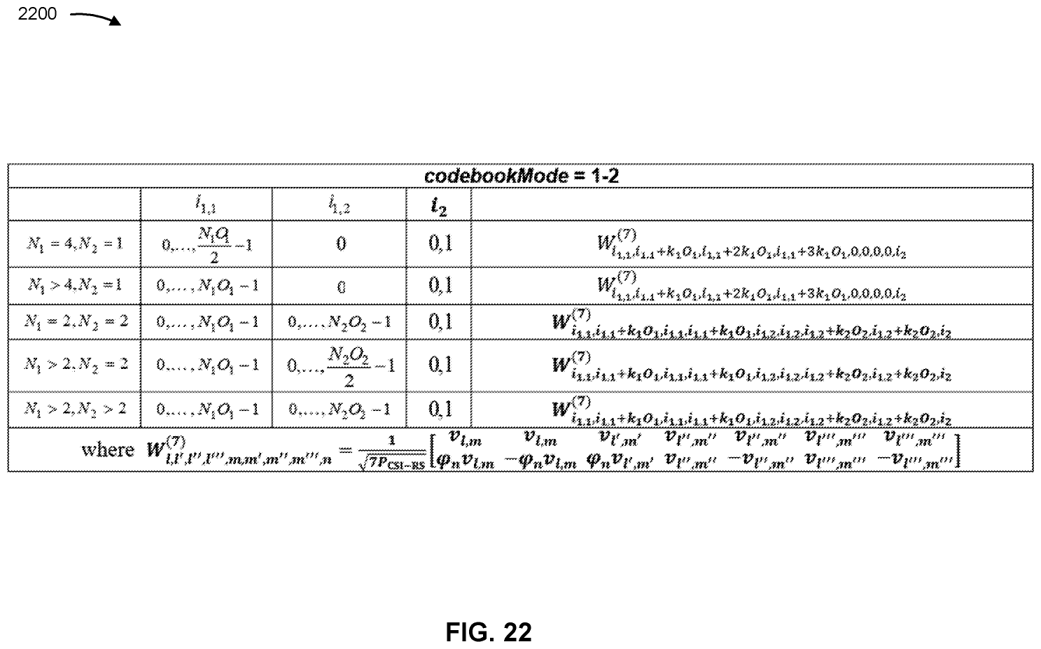

FIG. 22 is a diagram illustrating an example 2200 associated with a codebook for CSI reporting with a favorable angular property, in accordance with the present disclosure. As shown in FIG. 22, a codebook may be defined for 7-layer CSI reporting with a favorable angular property. For rank 7, the codebook may include k₁ and k₂, configured by a base station or selected by a UE, which may provide a relatively large angular distance between different beams associated with the 7 layers indicated in the codebook. As indicated above, FIG. 22 is provided as an example. Other examples may differ from what is described with regard to FIG. 22.

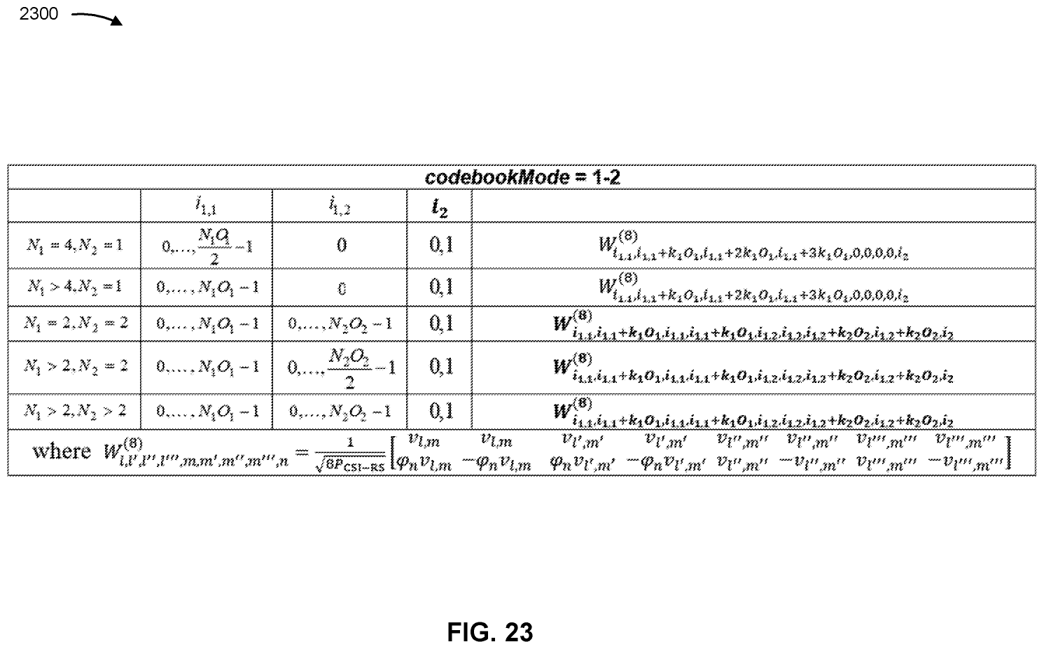

FIG. 23 is a diagram illustrating an example 2300 associated with a codebook for CSI reporting with a favorable angular property, in accordance with the present disclosure. As shown in FIG. 23, a codebook may be defined for 8-layer CSI reporting with a favorable angular property. For rank 8, the codebook may include k₁ and k₂, configured by a base station or selected by a UE, which may provide a relatively large angular distance between different beams associated with the 8 layers indicated in the codebook. As indicated above, FIG. 23 is provided as an example. Other examples may differ from what is described with regard to FIG. 23.

In some aspects, a beam selection capability may be added in an i₂ report, in addition to a co-phasing capability. In other words, a codebook may be designed such that i₂ selects one precoding matrix from a set of precoding matrices with different angular properties. The set of precoding matrices may be indicated using i_{1,1} and i_{1,2}, where i_{1,1}, i_{1,2}, and i₂ are associated with codebook indices.

In some aspects, for N₂>1, rank 5-8 codebooks with the beam selection capability may be defined, and such beam selection may be feasible when k₁>1 or k₂>1. In some aspects, for N₂=1, rank 5-8 codebooks with the beam selection capability may be defined, and such beam selection may be feasible when k₁>1.

FIG. 24 is a diagram illustrating an example 2400 associated with a codebook for CSI reporting with a beam selection capability, in accordance with the present disclosure. As shown in FIG. 24, a codebook may be defined for 5-layer CSI reporting with a beam selection capability for N₂>1. For rank 5 and for N₂>1, a codebook index i₂ may indicate a beam selection from a group of beams (or a selection of a value from a set of precoding matrices), based at least in part on the beam selection capability. As indicated above, FIG. 24 is provided as an example. Other examples may differ from what is described with regard to FIG. 24.

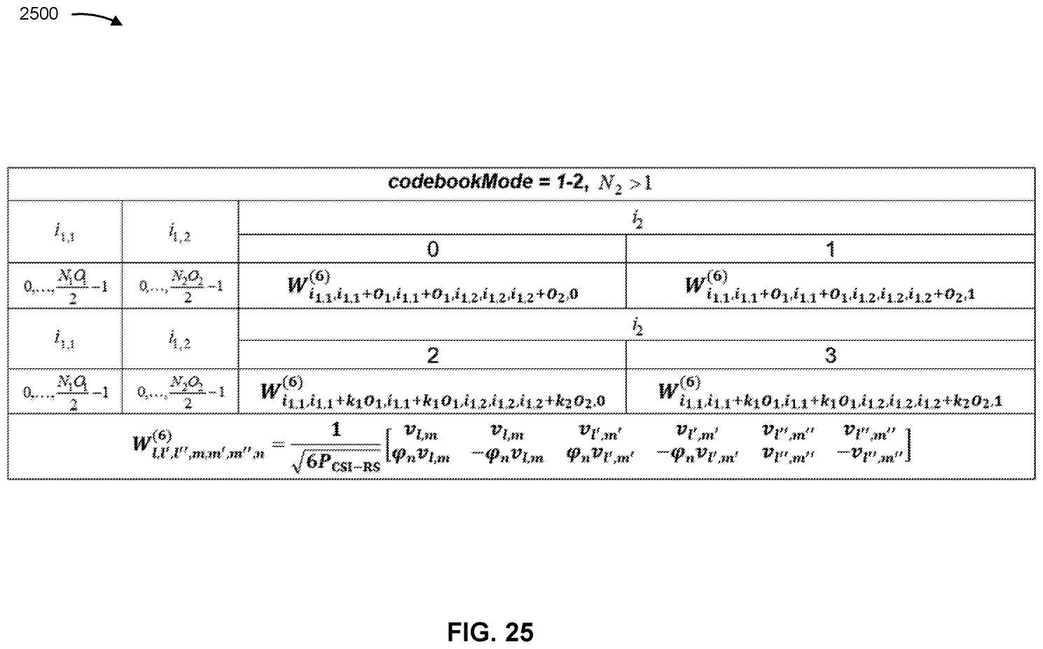

FIG. 25 is a diagram illustrating an example 2500 associated with a codebook for CSI reporting with a beam selection capability, in accordance with the present disclosure. As shown in FIG. 25, a codebook may be defined for 6-layer CSI reporting with a beam selection capability for N₂>1. For rank 6 and for N₂>1, a codebook index i₂ may indicate a beam selection from a group of beams (or a selection of a value from a set of precoding matrices), based at least in part on the beam selection capability. As indicated above, FIG. 25 is provided as an example. Other examples may differ from what is described with regard to FIG. 25.

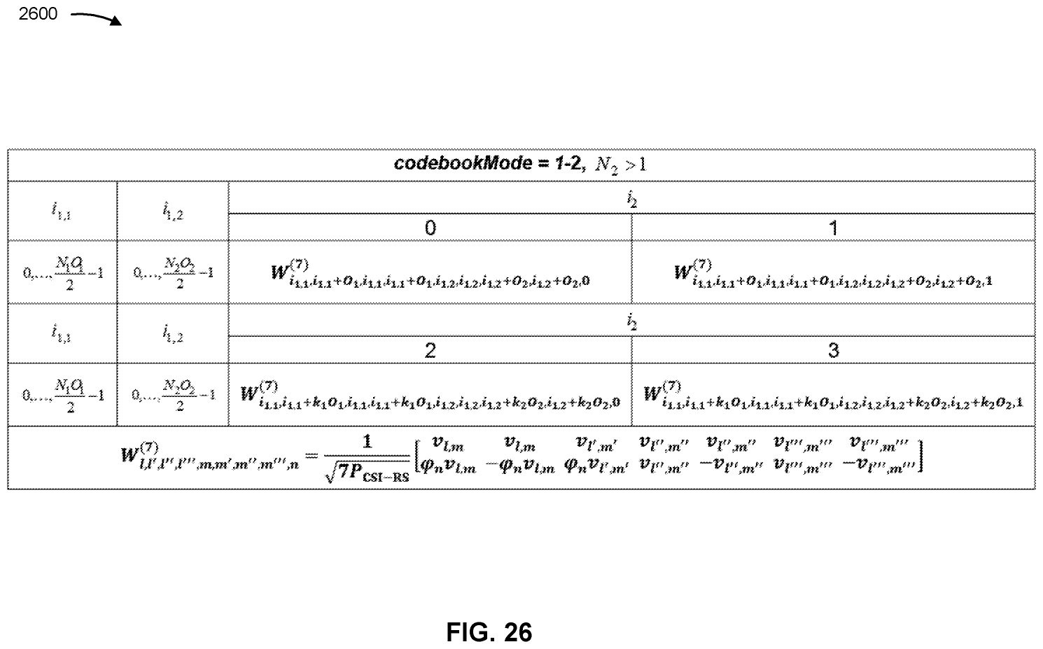

FIG. 26 is a diagram illustrating an example 2600 associated with a codebook for CSI reporting with a beam selection capability, in accordance with the present disclosure. As shown in FIG. 26, a codebook may be defined for 7-layer CSI reporting with a beam selection capability for N₂>1. For rank 7 and for N₂>1, a codebook index i₂ may indicate a beam selection from a group of beams (or a selection of a value from a set of precoding matrices), based at least in part on the beam selection capability. As indicated above, FIG. 26 is provided as an example. Other examples may differ from what is described with regard to FIG. 26.

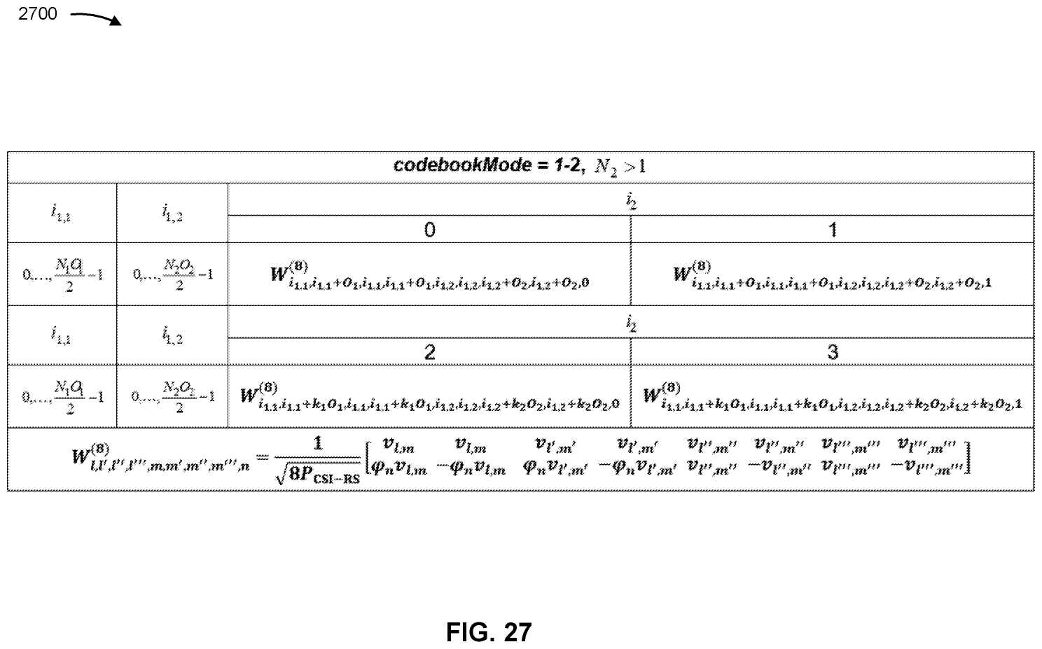

FIG. 27 is a diagram illustrating an example 2700 associated with a codebook for CSI reporting with a beam selection capability, in accordance with the present disclosure. As shown in FIG. 27, a codebook may be defined for 8-layer CSI reporting with a beam selection capability for N₂>1. For rank 8 and for N₂>1, a codebook index i₂ may indicate a beam selection from a group of beams (or a selection of a value from a set of precoding matrices), based at least in part on the beam selection capability. As indicated above, FIG. 27 is provided as an example. Other examples may differ from what is described with regard to FIG. 27.

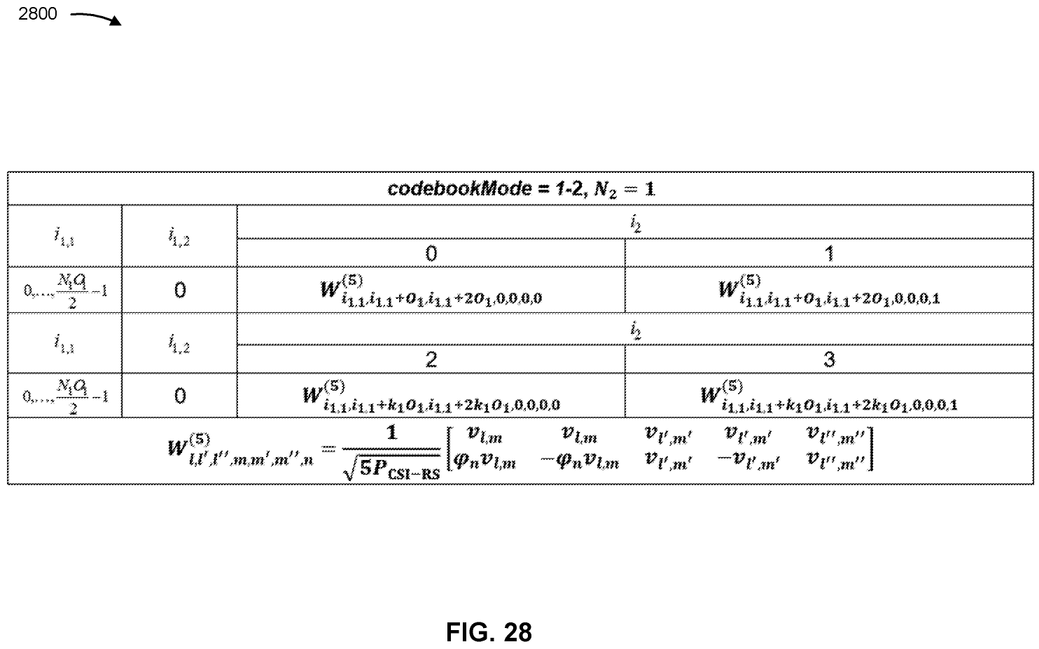

FIG. 28 is a diagram illustrating an example 2800 associated with a codebook for CSI reporting with a beam selection capability, in accordance with the present disclosure. As shown in FIG. 28, a codebook may be defined for 5-layer CSI reporting with a beam selection capability for N₂=1. For rank 5 and for N₂=1, a codebook index i₂ may indicate a beam selection from a group of beams (or a selection of a value from a set of precoding matrices), based at least in part on the beam selection capability. As indicated above, FIG. 28 is provided as an example. Other examples may differ from what is described with regard to FIG. 28.

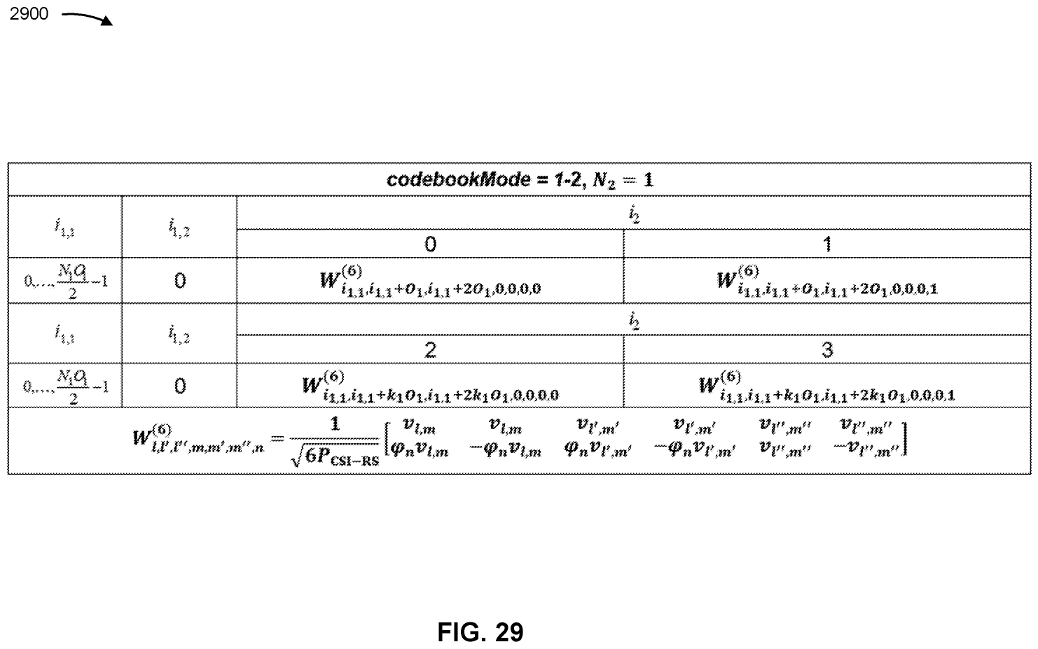

FIG. 29 is a diagram illustrating an example 2900 associated with a codebook for CSI reporting with a beam selection capability, in accordance with the present disclosure. As shown in FIG. 29, a codebook may be defined for 6-layer CSI reporting with a beam selection capability for N₂=1. For rank 6 and for N₂=1, a codebook index i₂ may indicate a beam selection from a group of beams (or a selection of a value from a set of precoding matrices), based at least in part on the beam selection capability. As indicated above, FIG. 29 is provided as an example. Other examples may differ from what is described with regard to FIG. 29.

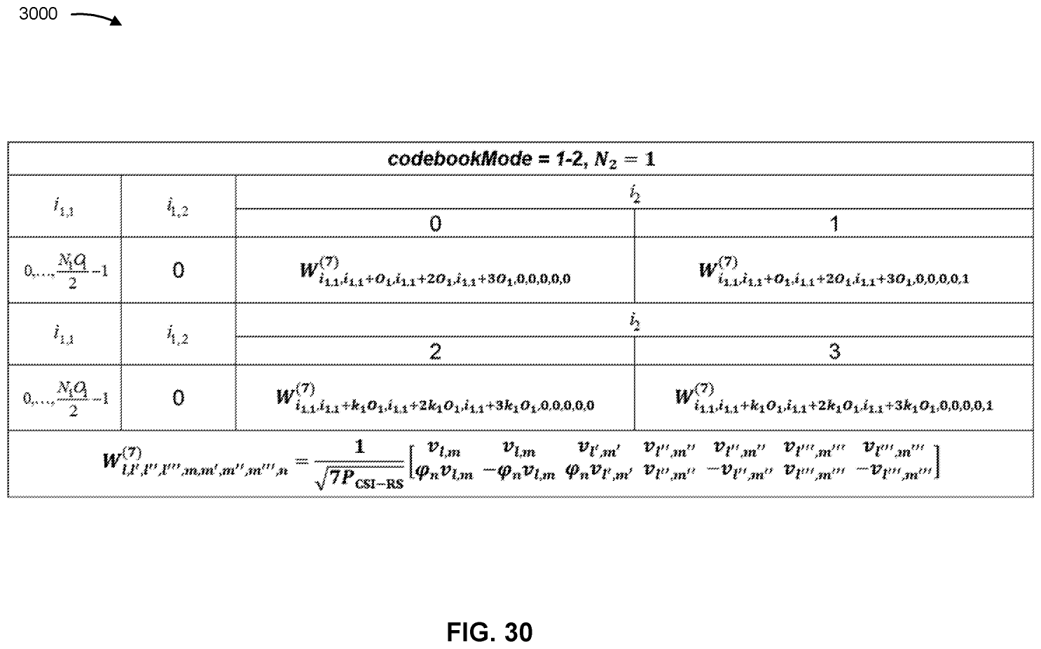

FIG. 30 is a diagram illustrating an example 3000 associated with a codebook for CSI reporting with a beam selection capability, in accordance with the present disclosure. As shown in FIG. 30, a codebook may be defined for 7-layer CSI reporting with a beam selection capability for N₂=1. For rank 7 and for N₂=1, a codebook index i₂ may indicate a beam selection from a group of beams (or a selection of a value from a set of precoding matrices), based at least in part on the beam selection capability. As indicated above, FIG. 30 is provided as an example. Other examples may differ from what is described with regard to FIG. 30.

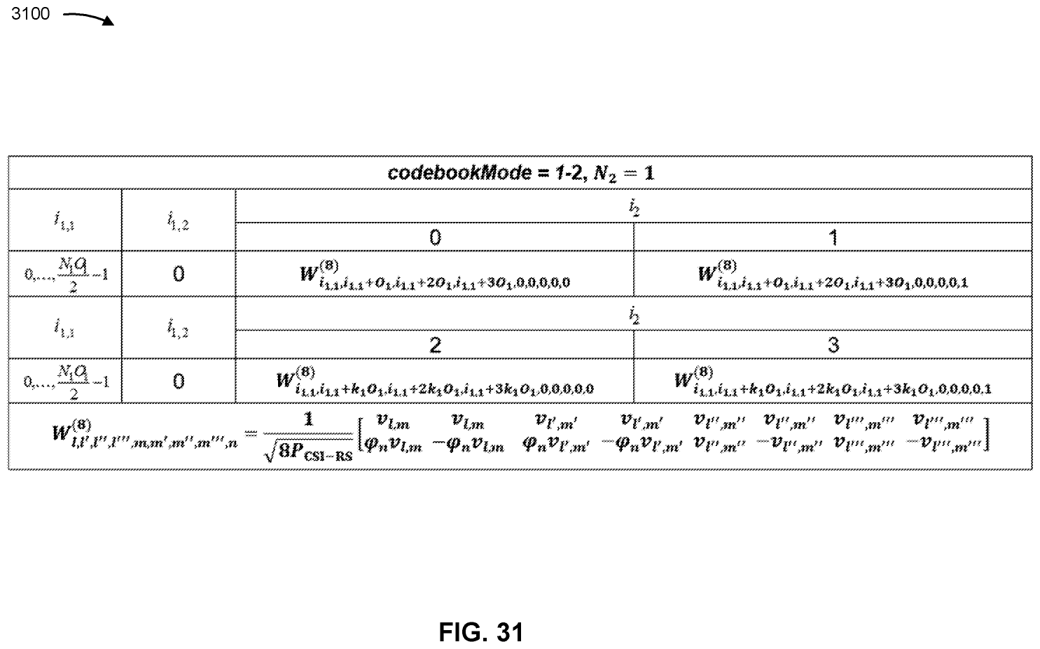

FIG. 31 is a diagram illustrating an example 3100 associated with a codebook for CSI reporting with a beam selection capability, in accordance with the present disclosure. As shown in FIG. 31, a codebook may be defined for 8-layer CSI reporting with a beam selection capability for N₂=1. For rank 8 and for N₂=1, a codebook index i₂ may indicate a beam selection from a group of beams (or a selection of a value from a set of precoding matrices), based at least in part on the beam selection capability. As indicated above, FIG. 31 is provided as an example. Other examples may differ from what is described with regard to FIG. 31.

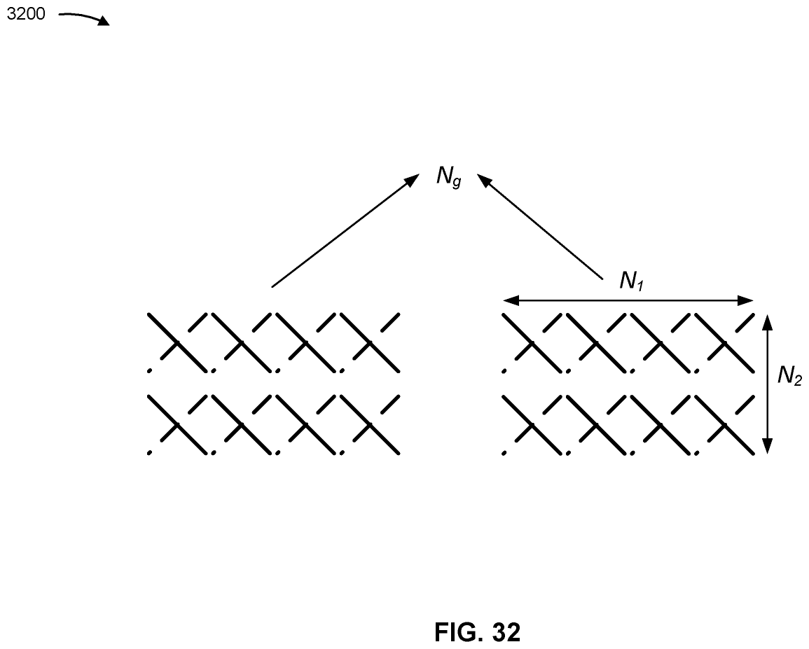

FIG. 32 is a diagram illustrating an example 3200 of an NR MIMO Type-I multi-panel codebook design, in accordance with the present disclosure. In an NR Type-I multi-panel codebook, multiple antenna panels (N_{g}) may be defined. Each antenna panel may be associated with N₁ antenna ports in the horizontal domain and N₂ antenna ports in the vertical domain. As indicated above, FIG. 32 is provided as an example. Other examples may differ from what is described with regard to FIG. 32.

In some aspects, an NR-MIMO Type-I multi-panel codebook may be associated with a Mode 1 or a Mode 2. In the NR-MIMO Type-I multi-panel codebook, for each antenna panel, a same structure of Type-I single-panel precoders may be applied. Between different antenna panels, a co-phasing may be applied to achieve an inter-panel coherent combining.

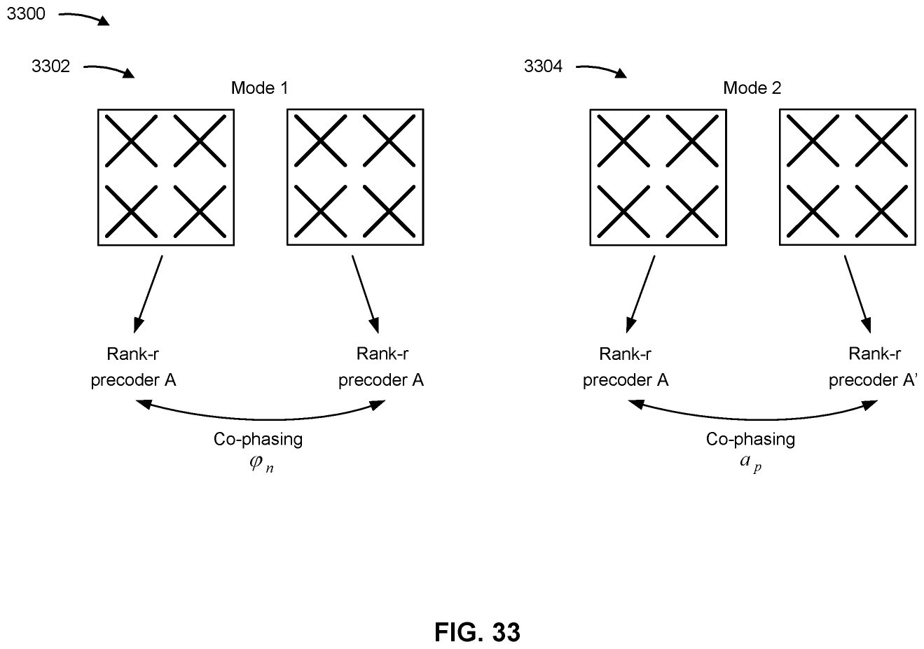

FIG. 33 is a diagram illustrating an example 3300 of an NR MIMO Type-I multi-panel codebook design, in accordance with the present disclosure.

As shown by reference number 3302, in Mode 1, precoder A may be applied to a first antenna panel associated with rank r, and precoder A may be applied to a second antenna panel associated with rank r. In other words, a same precoder may be applied to each antenna panel. Between the first antenna panel and the second antenna panel, a co-phasing (φₙ) may be applied.

As shown by reference number 3304, in Mode 2, precoder A may be applied to a first antenna panel associated with rank r, and precoder A′ may be applied to a second antenna panel associated with rank r. Precoder A and precoder A′ may apply a same beam for each polarization with respect to the two antenna panels, but different co-phasing factors for cross polarizations with respect to the two antenna panels. Further, between the first antenna panel and the second antenna panel, a co-phasing (aₚ) may be applied.

As indicated above, FIG. 33 is provided as an example. Other examples may differ from what is described with regard to FIG. 33.

For a Type-I multi-panel codebook, various codebook parameters may be defined. For 8 antenna ports {3000, 3001, . . . , 3007}, 16 antenna ports {3000, 3001, . . . , 3015}, and 32 antenna ports {3000, 3001, . . . , 3031}, and for a UE configured with higher layer parameter codebookType set to ‘typeI-MultiPanel’, values of N_{g}, N₁ and N₂ may be configured with higher layer parameters ng-n1-n2. Supported configurations of (N_{g}, N₁, N₂) may correspond to a given number of CSI-RS ports and corresponding values of (O₁, O₂). The number of CSI-RS ports, P_{CSI-RS}, may be equal to 2N_{g}N₁N₂. Further, when N_{g}=2, codebookMode may be set to either ‘1’ or ‘2’. When N_{g}=4, codebookMode may be set to ‘1’.

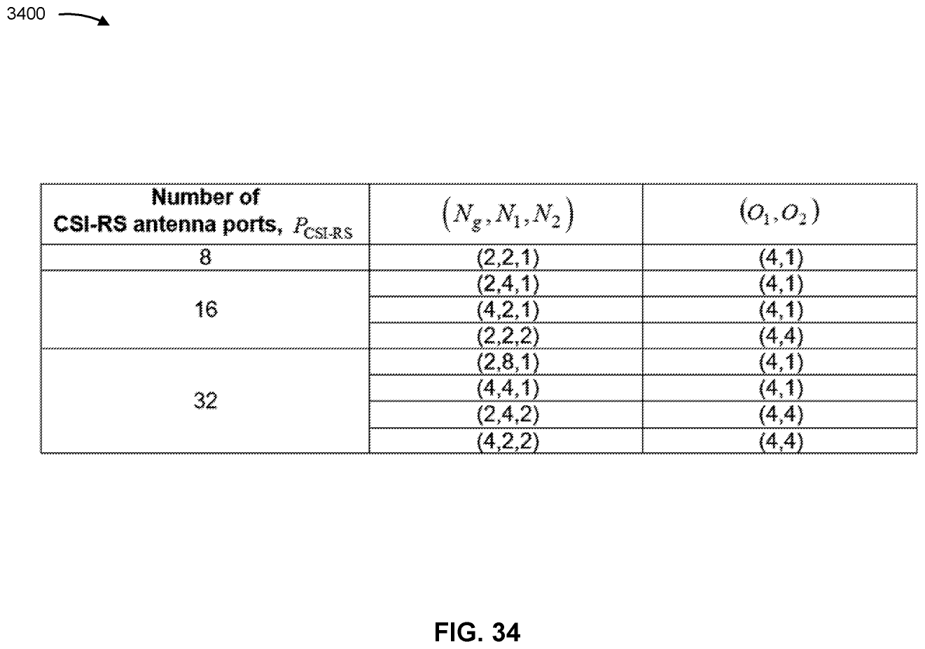

FIG. 34 is a diagram illustrating an example 3400 of supported configurations of (N_{g}, N₁, N₂) and (O₁, O₂), in accordance with the present disclosure. As shown in FIG. 34, depending on a number of CSI-RS antenna ports (P_{CSI-RS}), corresponding values of (N_{g}, N₁, N₂) and (O₁, O₂), may be configured. The number of CSI-RS antenna ports may be equal to 8, 16, or 32. As indicated above, FIG. 34 is provided as an example. Other examples may differ from what is described with regard to FIG. 34.

In some aspects, codebook elements may be defined using several quantities, which may include φₙ, aₚ, bₙ, uₘ, and ν_{l,m}, and which may be provided by:

$$\begin{matrix}{φ}_{n} = {e}^{j π n / 2} \\ {a}_{p} = {e}^{j π p / 4} \\ {b}_{n} = {e}^{- j π / 4} {e}^{j π n / 2} \\ {u}_{m} = \{ \begin{matrix}[ 1 {e}^{j \frac{2 π m}{{O}_{2} {N}_{2}}} … {e}^{j \frac{2 π m ( {N}_{2} - 1 )}{{O}_{2} {N}_{2}}} ] & {N}_{2} > 1 \\ 1 & {N}_{2} = 1\end{matrix} \\ {v}_{l , m} = {[ {u}_{m} {e}^{j \frac{2 π l}{{O}_{1} {N}_{1}}} {u}_{m} … {e}^{j \frac{2 π l ( {N}_{1} - 1 )}{{O}_{1} {N}_{1}}} {u}_{m} ]}^{T}\end{matrix}$$

Further, quantities W_{l,m,p,n}^{1,N}^{_{g}}^{,1} and W_{l,m,p,n}^{2,N}^{_{g}}^{,1} (N_{g}∈{2,4}) may be provided by:

$$\begin{matrix}{W}_{l , m , p , n}^{1 , 2 , 1} = \frac{1}{\sqrt{{P}_{CSI ‐ RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] {W}_{l , m , p , n}^{2 , 2 , 1} = \frac{1}{\sqrt{{P}_{CSI ‐ RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ] \\ {W}_{l , m , p , n}^{1 , 4 , 1} = \frac{1}{\sqrt{{P}_{CSI ‐ RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ] {W}_{l , m , p , n}^{2 , 4 , 1} = \frac{1}{\sqrt{{P}_{CSI ‐ RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ] \\ p = \{ \begin{matrix}{p}_{1} & {N}_{g} = 2 \\ [ \begin{matrix}{p}_{1} & {p}_{2} & {p}_{3}\end{matrix} ] & {N}_{g} = 4\end{matrix} ,\end{matrix} , where$$

and quantities W_{l,m,p,n}^{1,N}^{_{g}}^{,2} and W_{l,m,p,n}^{2,N}^{_{g}}^{,2} (N_{g}=2) may be provided by:

$${W}_{l , m , p , n}^{1 , 2 , 2} = \frac{1}{\sqrt{{P}_{CSI ‐ RS}}} [ \begin{matrix}{v}_{l , m} \\ {φ}_{{n}_{0}} {v}_{l , m} \\ {a}_{{p}_{1}} {b}_{{n}_{1}} {v}_{l , m} \\ {a}_{{p}_{2}} {b}_{{n}_{2}} {v}_{l , m}\end{matrix} ] {W}_{l , m , p , n}^{2 , 2 , 2} = \frac{1}{\sqrt{{P}_{CSI ‐ RS}}} [ \begin{matrix}{v}_{l , m} \\ - {φ}_{{n}_{0}} {v}_{l , m} \\ {a}_{{p}_{1}} {b}_{{n}_{1}} {v}_{l , m} \\ - {a}_{{p}_{2}} {b}_{{n}_{2}} {v}_{l , m}\end{matrix} ] , where \begin{matrix}p = [ \begin{matrix}{p}_{1} & {p}_{2} ]\end{matrix} \\ n = [ \begin{matrix}{n}_{0} & {n}_{1} & {n}_{2} ]\end{matrix}\end{matrix} .$$

In some aspects, with respect to a rank 5 multi-panel codebook design, a multi-panel codebook may be constructed by concatenating two or more single-panel precoders with co-phasing parameters. A rank 5 multi-panel codebook may be defined, where k₁ and k₂ may be set to be fixed values, e.g.,

$${k}_{1} = {k}_{2} = 1 or {k}_{1} = max ( 1 , ⌊ \frac{{N}_{1}}{2} ⌋ ) and {k}_{2} = max ( 1 , ⌊ \frac{{N}_{2}}{2} ⌋ ) ,$$

or k₁ and k₂ may be configured by a base station or selected by a UE. Further, a column permutation of a precoding matrix may not change a system performance, such that codebooks generated by different column permutations of illustrated designs may be equivalent designs.

FIG. 35 is a diagram illustrating an example 3500 associated with codebooks for CSI reporting in a multi-panel antenna configuration, in accordance with the present disclosure. As shown in FIG. 35, a codebook may be defined for 5-layer CSI reporting in a multi-panel antenna configuration for Mode 1. For rank 5, the codebook may be based at least in part on a concatenation of two or more single-panel precoders with panel co-phasing factors (or co-phasing parameters). For Mode 1, a same precoder (e.g., precoder A) may be applied to different antenna groups. As indicated above, FIG. 35 is provided as an example. Other examples may differ from what is described with regard to FIG. 35.

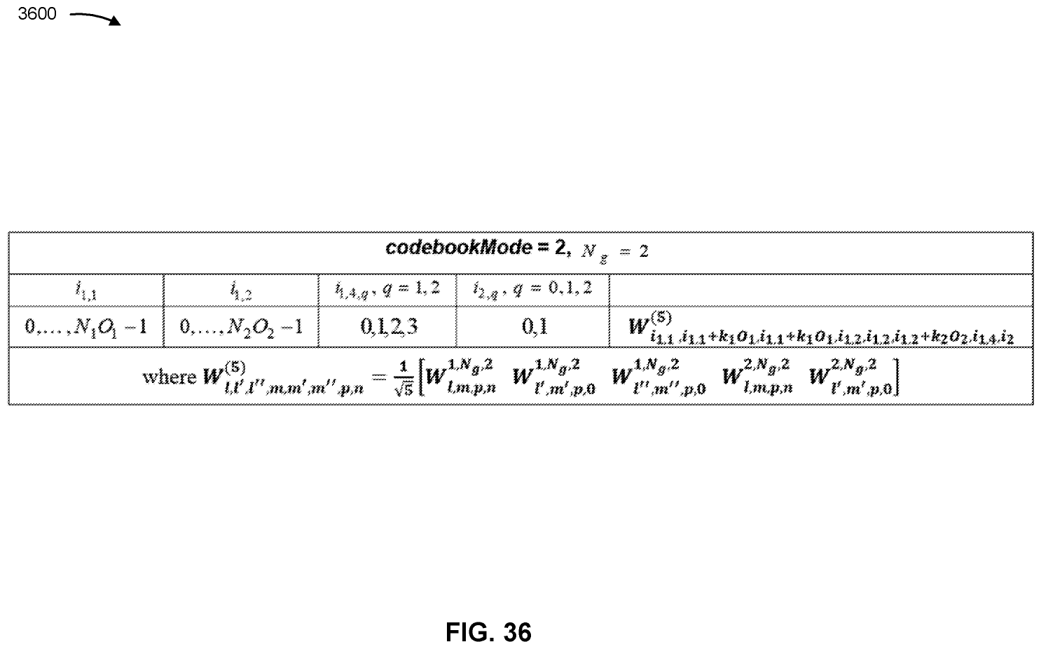

FIG. 36 is a diagram illustrating an example 3600 associated with codebooks for CSI reporting in a multi-panel antenna configuration, in accordance with the present disclosure. As shown in FIG. 36, a codebook may be defined for 5-layer CSI reporting in a multi-panel antenna configuration for Mode 2. For rank 5, the codebook may be based at least in part on a concatenation of two or more single-panel precoders with panel co-phasing factors. For Mode 2, different precoders (e.g., precoder A and precoder A′) may be applied to different antenna groups. As indicated above, FIG. 36 is provided as an example. Other examples may differ from what is described with regard to FIG. 36.

In some aspects, each antenna panel may be assumed to be associated with a rank 5 and 2N₁N₂ transmit antennas, such that 2N₁N₂≥5 may be satisfied.

In some aspects, with respect to a rank 6 multi-panel codebook design, a rank 6 multi-panel codebook may be defined, where k₁ and k₂ may be set to be fixed values, e.g.,

$${k}_{1} = {k}_{2} = 1 or {k}_{1} = max ( 1 , ⌊ \frac{{N}_{1}}{2} ⌋ ) and {k}_{2} = max ( 1 , ⌊ \frac{{N}_{2}}{2} ⌋ ) ,$$

or k₁ and k₂ may be configured by a base station or selected by a UE. Similar to a rank 5 multi-panel codebook, rank 6 multi-panel codebooks generated by column permutations of illustrated designs may be equivalent designs.

In some aspects, each antenna panel may be assumed to be associated with a rank 6 and 2N₁N₂ transmit antennas, such that 2N₁N₂≥6 may be satisfied.

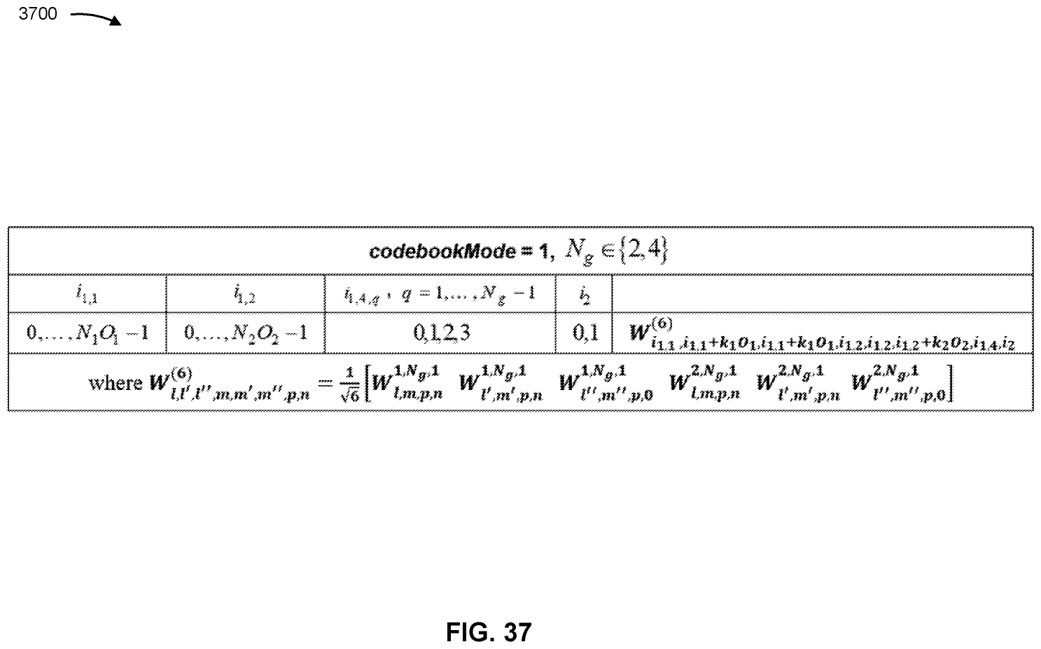

FIG. 37 is a diagram illustrating an example 3700 associated with codebooks for CSI reporting in a multi-panel antenna configuration, in accordance with the present disclosure. As shown in FIG. 37, a codebook may be defined for 6-layer CSI reporting in a multi-panel antenna configuration for Mode 1. For rank 6, the codebook may be based at least in part on a concatenation of two or more single-panel precoders with panel co-phasing factors. For Mode 1, a same precoder (e.g., precoder A) may be applied to different antenna groups. As indicated above, FIG. 37 is provided as an example. Other examples may differ from what is described with regard to FIG. 37.

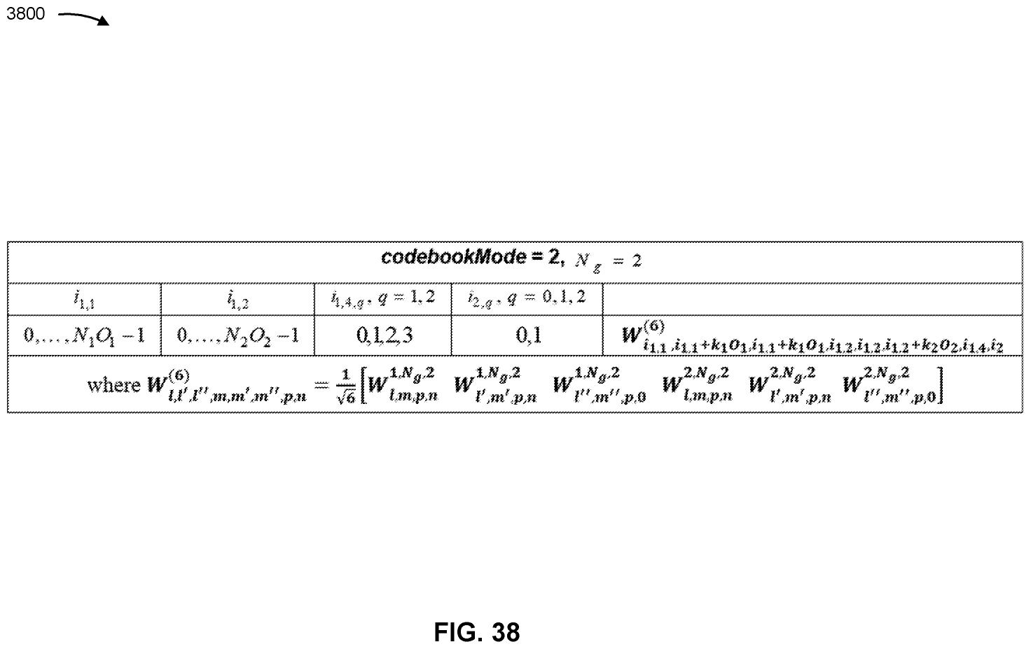

FIG. 38 is a diagram illustrating an example 3800 associated with codebooks for CSI reporting in a multi-panel antenna configuration, in accordance with the present disclosure. As shown in FIG. 38, a codebook may be defined for 6-layer CSI reporting in a multi-panel antenna configuration for Mode 2. For rank 6, the codebook may be based at least in part on a concatenation of two or more single-panel precoders with panel co-phasing factors. For Mode 2, different precoders (e.g., precoder A and precoder A′) may be applied to different antenna groups. As indicated above, FIG. 38 is provided as an example. Other examples may differ from what is described with regard to FIG. 38.

In some aspects, with respect to a rank 7 multi-panel codebook design, a rank 7 multi-panel codebook may be defined, where k₁ and k₂ may be set to be fixed values, e.g.,

$${k}_{1} = {k}_{2} = 1 or {k}_{1} = max ( 1 , ⌊ \frac{{N}_{1}}{2} ⌋ ) and {k}_{2} = max ( 1 , ⌊ \frac{{N}_{2}}{2} ⌋ ) ,$$

or k₁ and k₂ may be configured by a base station or selected by a UE. Similar to a rank 5 multi-panel codebook, rank 7 multi-panel codebooks generated by column permutations of illustrated designs may be equivalent designs.

In some aspects, each antenna panel may be assumed to be associated with a rank 7 and 2N₁N₂ transmit antennas, such that 2N₁N₂≥7 may be satisfied.

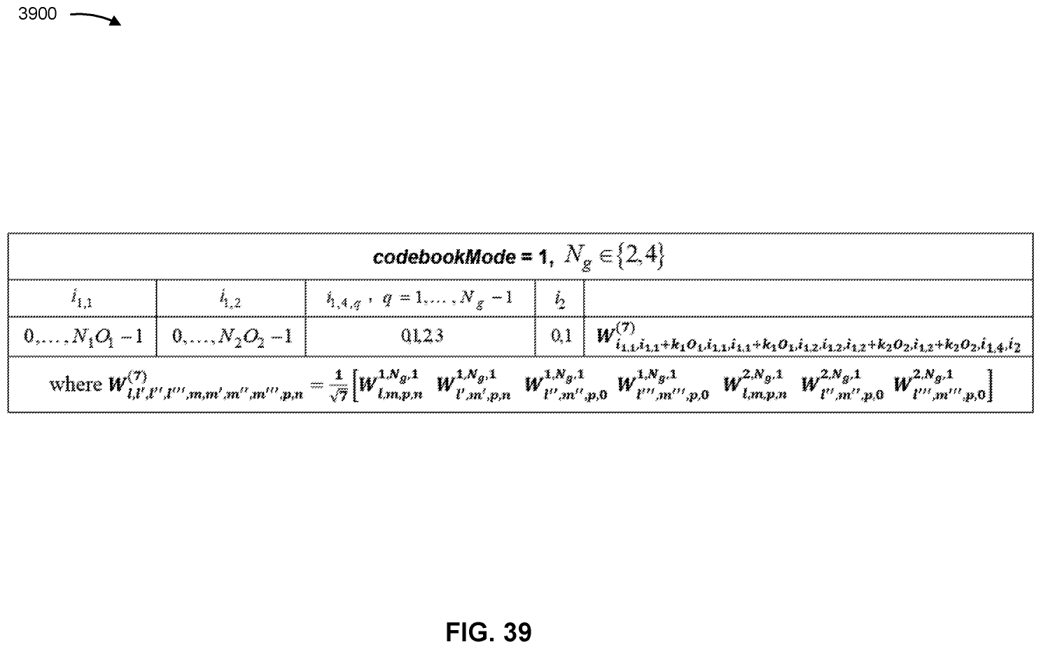

FIG. 39 is a diagram illustrating an example 3900 associated with codebooks for CSI reporting in a multi-panel antenna configuration, in accordance with the present disclosure. As shown in FIG. 39, a codebook may be defined for 7-layer CSI reporting in a multi-panel antenna configuration for Mode 1. For rank 7, the codebook may be based at least in part on a concatenation of two or more single-panel precoders with panel co-phasing factors. For Mode 1, a same precoder (e.g., precoder A) may be applied to different antenna groups. As indicated above, FIG. 39 is provided as an example. Other examples may differ from what is described with regard to FIG. 39.

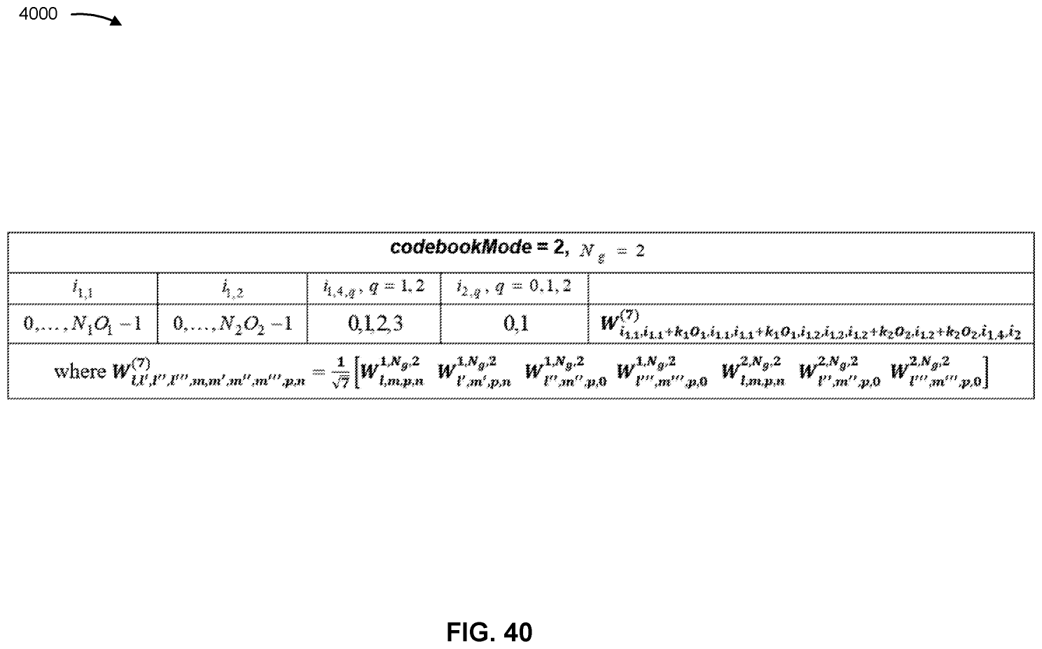

FIG. 40 is a diagram illustrating an example 4000 associated with codebooks for CSI reporting in a multi-panel antenna configuration, in accordance with the present disclosure. As shown in FIG. 40, a codebook may be defined for 7-layer CSI reporting in a multi-panel antenna configuration for Mode 2. For rank 7, the codebook may be based at least in part on a concatenation of two or more single-panel precoders with panel co-phasing factors. For Mode 2, different precoders (e.g., precoder A and precoder A′) may be applied to different antenna groups. As indicated above, FIG. 40 is provided as an example. Other examples may differ from what is described with regard to FIG. 40.

In some aspects, with respect to a rank 8 multi-panel codebook design, a rank 8 multi-panel codebook may be defined, where k₁ and k₂ may be fixed values, e.g.,

$${k}_{1} = {k}_{2} = 1 or {k}_{1} = max ( 1 , ⌊ \frac{{N}_{1}}{2} ⌋ ) and {k}_{2} = max ( 1 , ⌊ \frac{{N}_{2}}{2} ⌋ ) ,$$

or k₁ and k₂ may be configured by a base station or selected by a UE. Similar to a rank 5 multi-panel codebook, rank 8 multi-panel codebooks generated by column permutations of illustrated designs may be equivalent designs.

In some aspects, each antenna panel may be assumed to be associated with a rank 8 and 2N₁N₂ transmit antennas, such that 2N₁N₂≥8 may be satisfied.

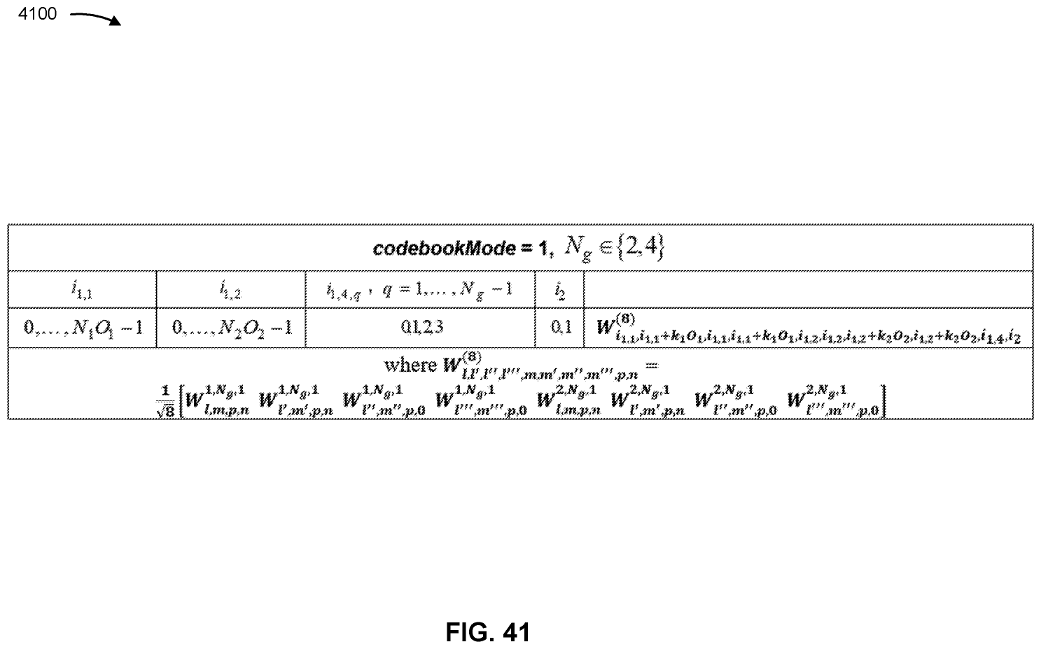

FIG. 41 is a diagram illustrating an example 4100 associated with codebooks for CSI reporting in a multi-panel antenna configuration, in accordance with the present disclosure. As shown in FIG. 41, a codebook may be defined for 8-layer CSI reporting in a multi-panel antenna configuration for Mode 1. For rank 8, the codebook may be based at least in part on a concatenation of two or more single-panel precoders with panel co-phasing factors. For Mode 1, a same precoder (e.g., precoder A) may be applied to different antenna groups. As indicated above, FIG. 41 is provided as an example. Other examples may differ from what is described with regard to FIG. 41.

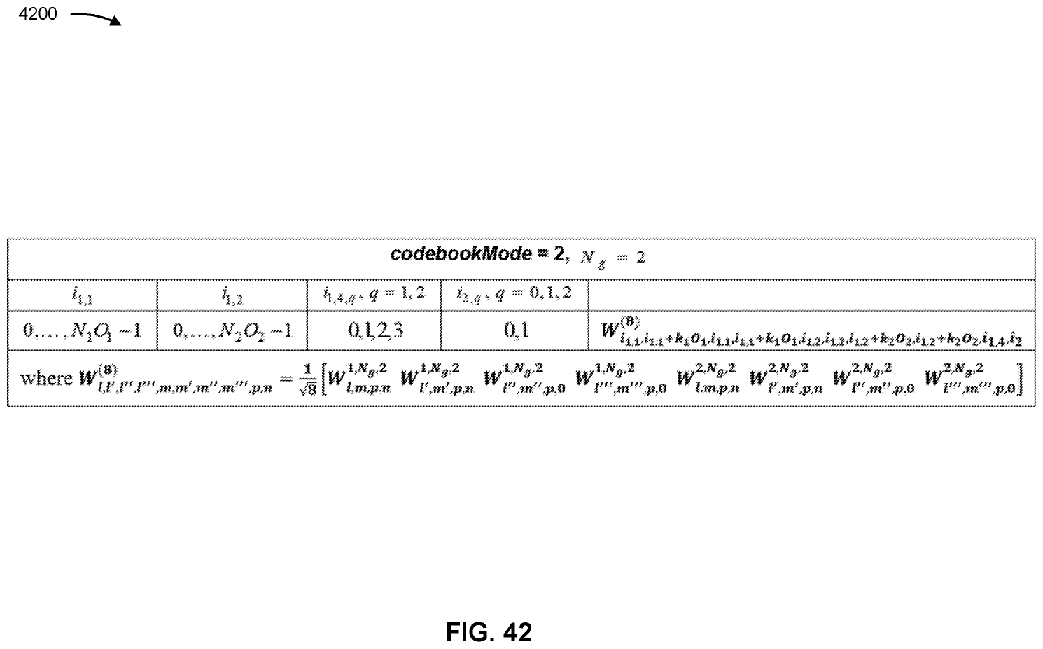

FIG. 42 is a diagram illustrating an example 4200 associated with codebooks for CSI reporting in a multi-panel antenna configuration, in accordance with the present disclosure. As shown in FIG. 42, a codebook may be defined for 8-layer CSI reporting in a multi-panel antenna configuration for Mode 2. For rank 8, the codebook may be based at least in part on a concatenation of two or more single-panel precoders with panel co-phasing factors. For Mode 2, different precoders (e.g., precoder A and precoder A′) may be applied to different antenna groups. As indicated above, FIG. 42 is provided as an example. Other examples may differ from what is described with regard to FIG. 42.

FIG. 43 is a diagram illustrating an example 4300 of antenna configurations supported by a Type-I multi-panel rank 5-8 codebook, in accordance with the present disclosure.

As shown in FIG. 43, depending on a number of CSI-RS antenna ports (P_{CSI-RS}), corresponding values of (N_{g}, N₁, N₂) and (O₁, O₂), may be configured. The number of CSI-RS antenna ports may be equal to 16 or 32. The antenna configurations supported by the Type-I multi-panel rank 5-8 codebook may be based at least in part on 2N₁N₂≥5 being satisfied for each antenna panel being associated with rank 5 and 2N₁N₂ transmit antennas, 2N₁N₂≥6 being satisfied for each antenna panel being associated with rank 6 and 2N₁N₂ transmit antennas, 2N₁N₂≥7 being satisfied for each antenna panel being associated with rank 7 and 2N₁N₂ transmit antennas, and 2N₁N₂≥8 being satisfied for each antenna panel being associated with rank 8 and 2N₁N₂ transmit antennas.

As indicated above, FIG. 43 is provided as an example. Other examples may differ from what is described with regard to FIG. 43.

In some aspects, with respect to a rank 5-8 multi-panel codebook design, rank 5-8 multi-panel codebooks may be defined using different co-phasing techniques, as compared to earlier described rank 5-8 multi-panel codebooks. For example, a different co-phasing technique may involve including a co-phasing factor for each beam indicated in the rank 5-8 multi-panel codebook, as opposed to only including a co-phasing factor for some beams indicated in the rank 5-8 multi-panel codebook. An inclusion of the co-phasing factor for each beam indicated in the rank 5-8 multi-panel codebook may improve a performance associated with the rank 5-8 multi-panel codebook.

FIG. 44 is a diagram illustrating an example 4400 associated with codebooks for CSI reporting in a multi-panel antenna configuration with a different co-phasing technique, in accordance with the present disclosure. As shown in FIG. 44, a codebook may be defined for 5-layer CSI reporting in a multi-panel antenna configuration with a different co-phasing technique for Mode 1. For rank 5, a co-phasing factor may be applied for each beam indicated in the codebook. As indicated above, FIG. 44 is provided as an example. Other examples may differ from what is described with regard to FIG. 44.

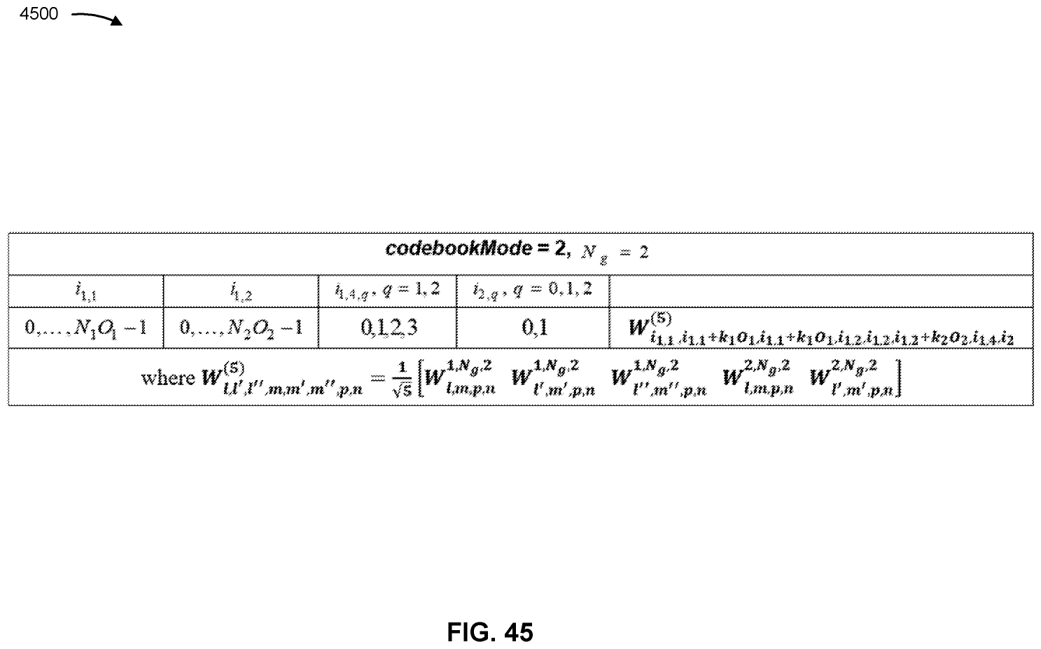

FIG. 45 is a diagram illustrating an example 4500 associated with codebooks for CSI reporting in a multi-panel antenna configuration with a different co-phasing technique, in accordance with the present disclosure. As shown in FIG. 45, a codebook may be defined for 5-layer CSI reporting in a multi-panel antenna configuration with a different co-phasing technique for Mode 2. For rank 5, a co-phasing factor may be applied for each beam indicated in the codebook. As indicated above, FIG. 45 is provided as an example. Other examples may differ from what is described with regard to FIG. 45.

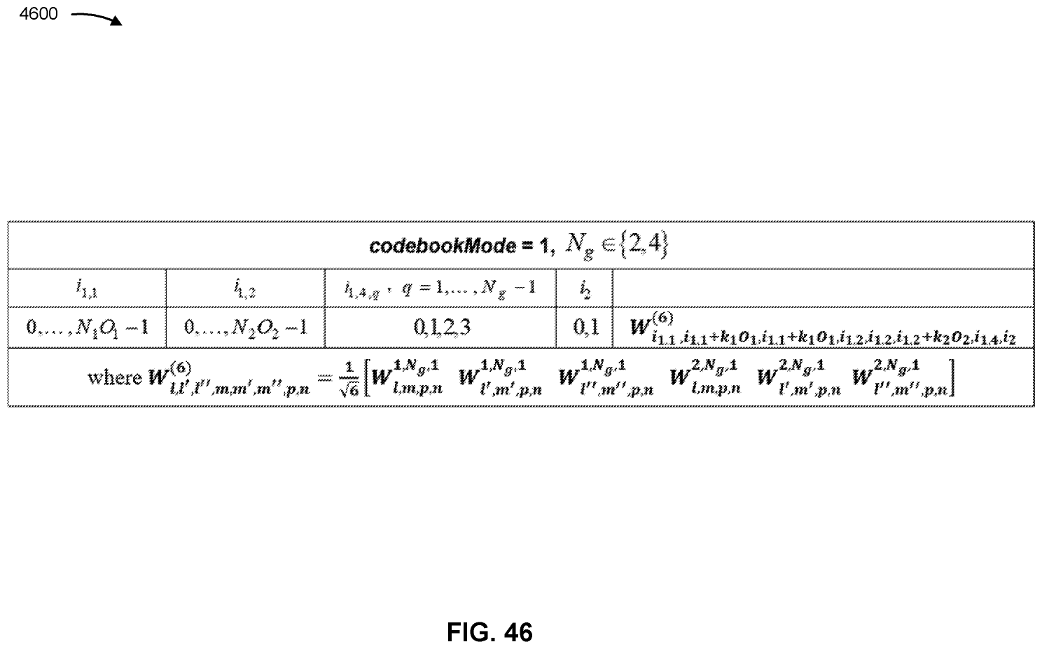

FIG. 46 is a diagram illustrating an example 4600 associated with codebooks for CSI reporting in a multi-panel antenna configuration with a different co-phasing technique, in accordance with the present disclosure. As shown in FIG. 46, a codebook may be defined for 6-layer CSI reporting in a multi-panel antenna configuration with a different co-phasing technique for Mode 1. For rank 6, a co-phasing factor may be applied for each beam indicated in the codebook. As indicated above, FIG. 46 is provided as an example. Other examples may differ from what is described with regard to FIG. 46.

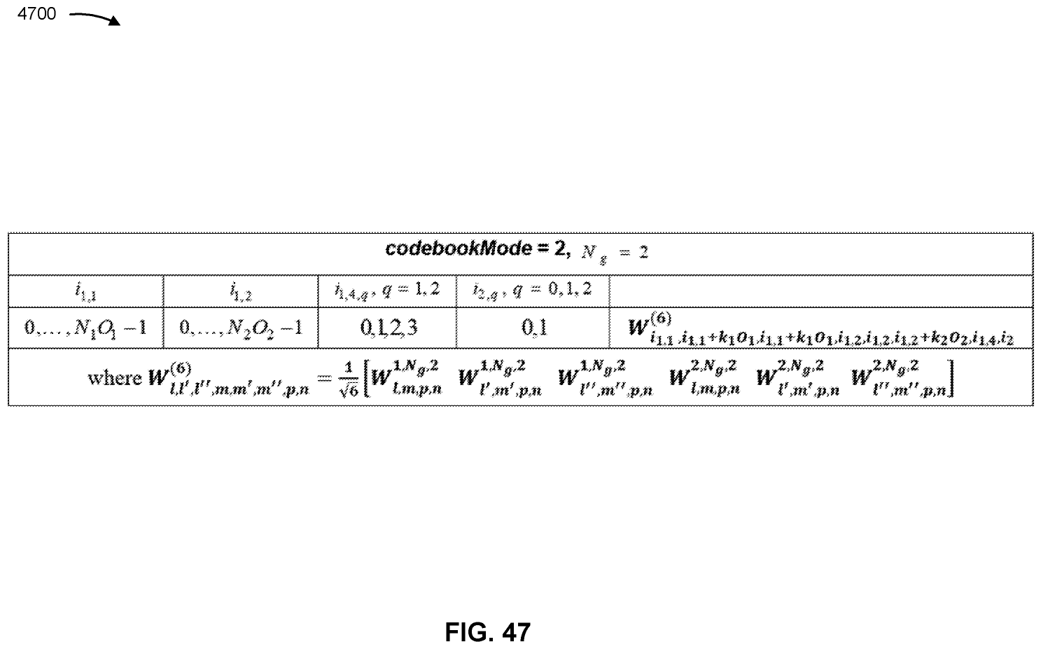

FIG. 47 is a diagram illustrating an example 4700 associated with codebooks for CSI reporting in a multi-panel antenna configuration with a different co-phasing technique, in accordance with the present disclosure. As shown in FIG. 47, a codebook may be defined for 6-layer CSI reporting in a multi-panel antenna configuration with a different co-phasing technique for Mode 2. For rank 6, a co-phasing factor may be applied for each beam indicated in the codebook. As indicated above, FIG. 47 is provided as an example. Other examples may differ from what is described with regard to FIG. 47.

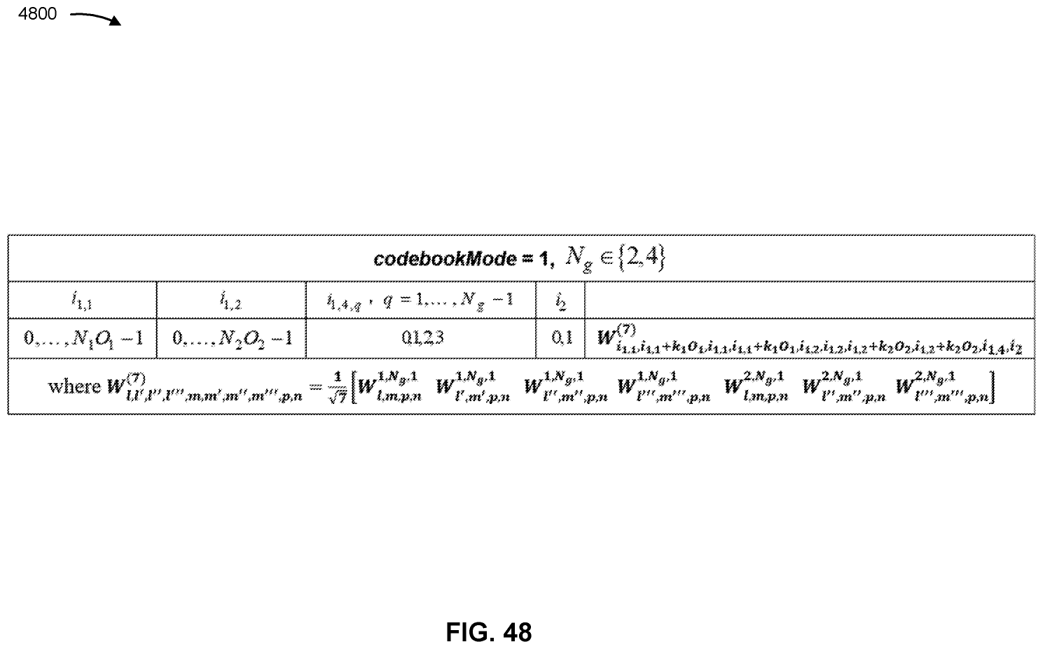

FIG. 48 is a diagram illustrating an example 4800 associated with codebooks for CSI reporting in a multi-panel antenna configuration with a different co-phasing technique, in accordance with the present disclosure. As shown in FIG. 48, a codebook may be defined for 7-layer CSI reporting in a multi-panel antenna configuration with a different co-phasing technique for Mode 1. For rank 7, a co-phasing factor may be applied for each beam indicated in the codebook. As indicated above, FIG. 48 is provided as an example. Other examples may differ from what is described with regard to FIG. 48.

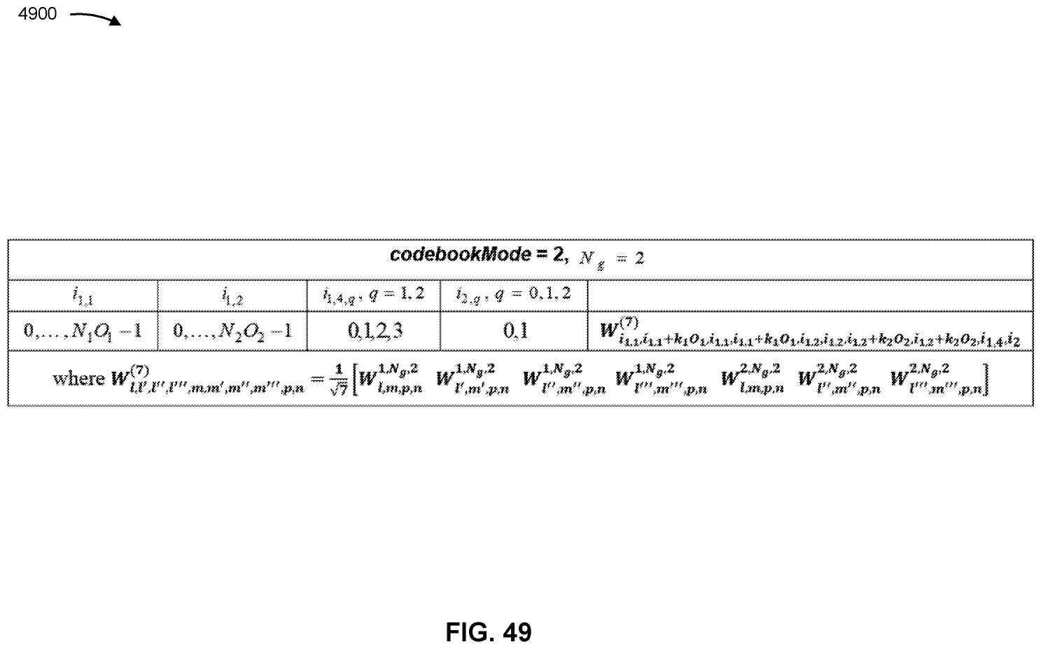

FIG. 49 is a diagram illustrating an example 4900 associated with codebooks for CSI reporting in a multi-panel antenna configuration with a different co-phasing technique, in accordance with the present disclosure. As shown in FIG. 49, a codebook may be defined for 7-layer CSI reporting in a multi-panel antenna configuration with a different co-phasing technique for Mode 2. For rank 7, a co-phasing factor may be applied for each beam indicated in the codebook. As indicated above, FIG. 49 is provided as an example. Other examples may differ from what is described with regard to FIG. 49.

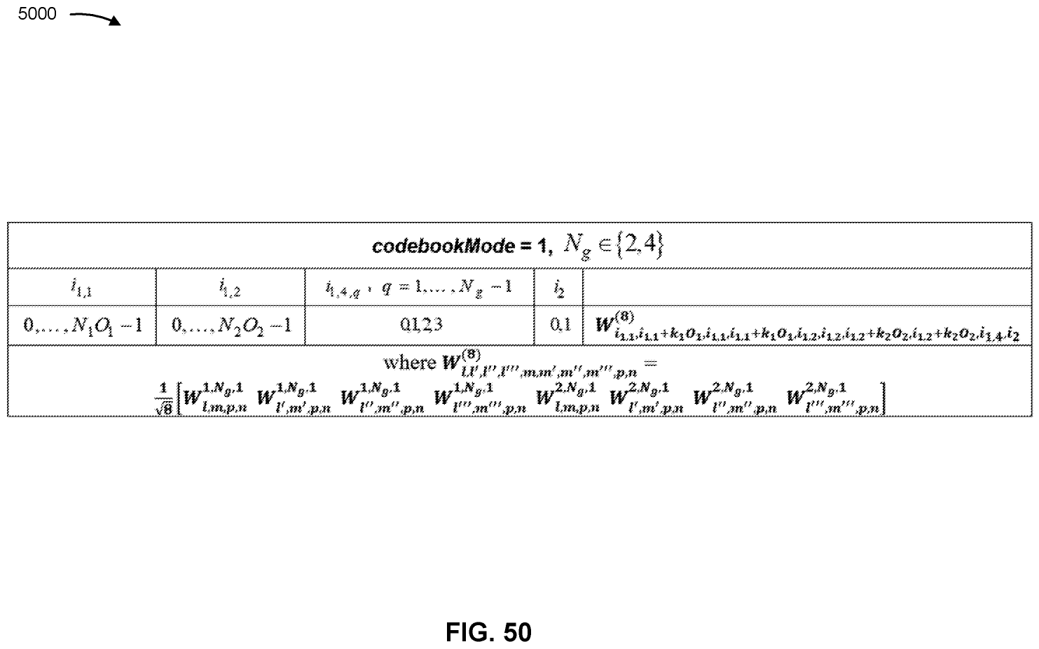

FIG. 50 is a diagram illustrating an example 5000 associated with codebooks for CSI reporting in a multi-panel antenna configuration with a different co-phasing technique, in accordance with the present disclosure. As shown in FIG. 50, a codebook may be defined for 8-layer CSI reporting in a multi-panel antenna configuration with a different co-phasing technique for Mode 1. For rank 8, a co-phasing factor may be applied for each beam indicated in the codebook. As indicated above, FIG. 50 is provided as an example. Other examples may differ from what is described with regard to FIG. 50.

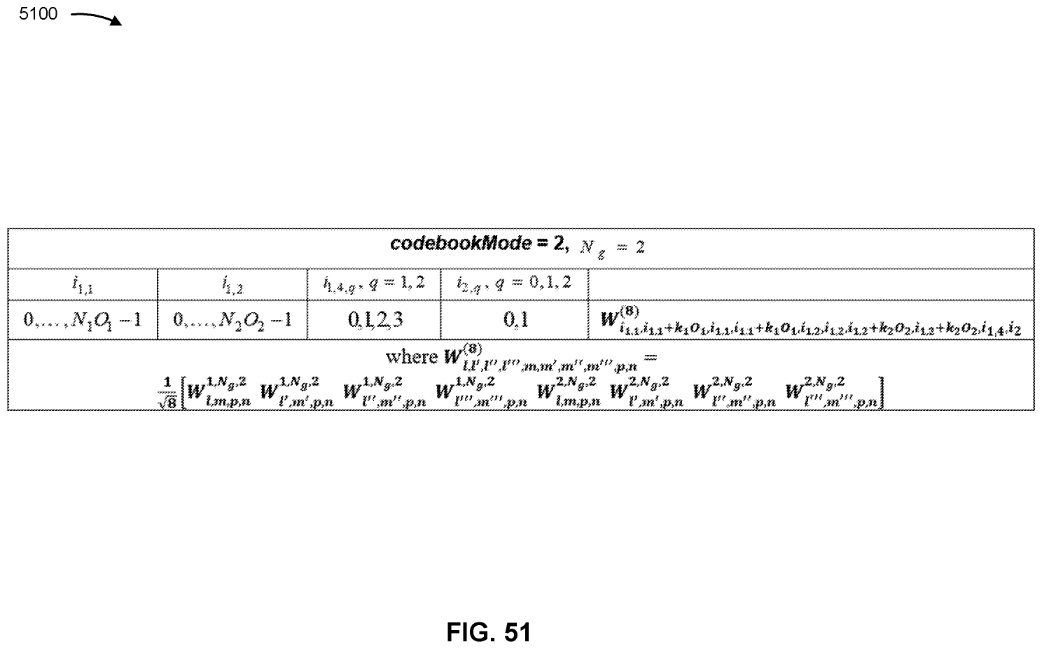

FIG. 51 is a diagram illustrating an example 5100 associated with codebooks for CSI reporting in a multi-panel antenna configuration with a different co-phasing technique, in accordance with the present disclosure. As shown in FIG. 51, a codebook may be defined for 8-layer CSI reporting in a multi-panel antenna configuration with a different co-phasing technique for Mode 2. For rank 8, a co-phasing factor may be applied for each beam indicated in the codebook. As indicated above, FIG. 51 is provided as an example. Other examples may differ from what is described with regard to FIG. 51.

FIG. 52 is a diagram illustrating an example process 5200 performed, for example, by a UE, in accordance with the present disclosure. Example process 5200 is an example where the UE (e.g., UE 120) performs operations associated with CSI reporting using codebooks.

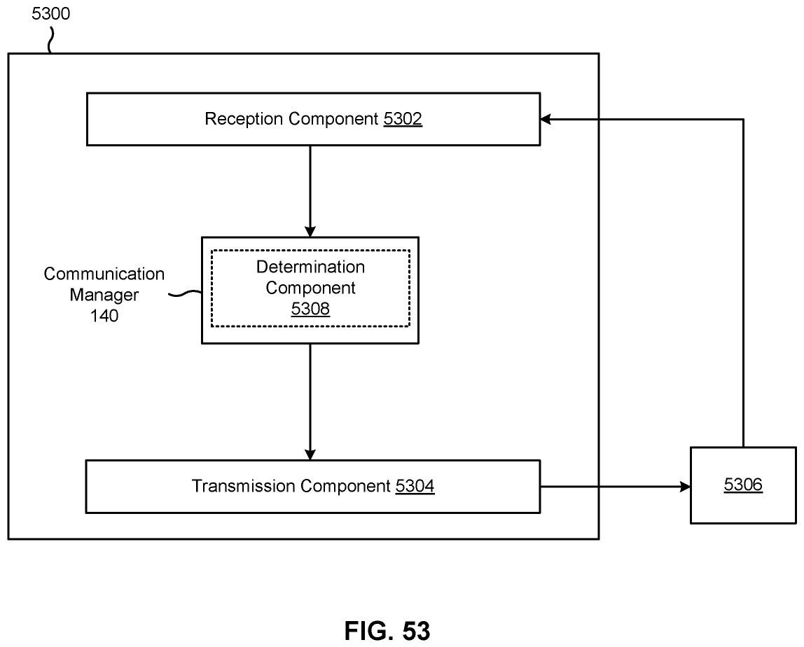

As shown in FIG. 52, in some aspects, process 5200 may include determining one or more parameters for a rank 5-8 Type-I codebook (block 5210). For example, the UE (e.g., using communication manager 140 and/or determination component 5308, depicted in FIG. 53) may determine one or more parameters for a rank 5-8 Type-I codebook, as described above.

As further shown in FIG. 52, in some aspects, process 5200 may include performing, to a base station, a rank 5-8 CSI reporting based at least in part on the rank 5-8 Type-I codebook that includes the one or more parameters (block 5220). For example, the UE (e.g., using communication manager 140 and/or transmission component 5304, depicted in FIG. 53) may perform, to a base station, a rank 5-8 CSI reporting based at least in part on the rank 5-8 Type-I codebook that includes the one or more parameters, as described above.

Process 5200 may include additional aspects, such as any single aspect or any combination of aspects described below and/or in connection with one or more other processes described elsewhere herein.

In a first aspect, the rank 5-8 Type-I codebook is a single-panel rank 5-8 Type-I codebook.

In a second aspect, alone or in combination with the first aspect, the one or more parameters for the rank 5-8 Type-I codebook include beam-specific co-phasing factors, wherein a co-phasing factor is defined for each beam indicated in the rank 5-8 Type-I codebook.

In a third aspect, alone or in combination with one or more of the first and second aspects, the one or more parameters for the rank 5-8 Type-I codebook include a first co-phasing factor applied for a cross-polarization associated with the rank 5-8 Type-I codebook, and a second co-phasing factor applied for different antenna groups formed from a plurality of transmit antennas associated with the UE.

In a fourth aspect, alone or in combination with one or more of the first through third aspects, the one or more parameters for the rank 5-8 Type-I codebook include a first integer value and a second integer value to provide an angular distance between different beams, as indicated in the rank 5-8 Type-I codebook, that satisfies a threshold.

In a fifth aspect, alone or in combination with one or more of the first through fourth aspects, process 5200 includes receiving, from the base station, an indication of the one or more parameters for the rank 5-8 Type-I codebook.

In a sixth aspect, alone or in combination with one or more of the first through fifth aspects, process 5200 includes selecting the one or more parameters for the rank 5-8 Type-I codebook at the UE.

In a seventh aspect, alone or in combination with one or more of the first through sixth aspects, the one or more parameters for the rank 5-8 Type-I codebook include a first codebook index, a second codebook index, and a third codebook index, wherein the first codebook index and the second codebook index are associated with a wideband channel and indicate a group of beams, and the third codebook index is associated with a sub-band channel and indicates a beam selection from the group of beams.

In an eighth aspect, alone or in combination with one or more of the first through seventh aspects, the third codebook index is based at least in part on a quantity of antenna elements in a vertical domain.

In a ninth aspect, alone or in combination with one or more of the first through eighth aspects, the rank 5-8 Type-I codebook is a multi-panel rank 5-8 Type-I codebook.

In a tenth aspect, alone or in combination with one or more of the first through ninth aspects, the multi-panel rank 5-8 Type-I codebook is based at least in part on a concatenation of two or more single-panel rank 5-8 Type-I precoders with panel co-phasing factors.

In an eleventh aspect, alone or in combination with one or more of the first through tenth aspects, the multi-panel rank 5-8 Type-I codebook is associated with a first mode, wherein a same precoder is applied to different antenna panels based at least in part on the first mode, or the multi-panel rank 5-8 Type-I codebook is associated with a second mode, wherein a first precoder is applied to a first antenna panel and a second precoder is applied to a second antenna panel based at least in part on the second mode, wherein the first precoder and the second precoder apply a same beam for each polarization associated with the first antenna panel and the second antenna panel, and the first precoder applies first co-phasing factors for cross polarizations associated with the first antenna panel and the second precoder applies second co-phasing factors for cross polarizations associated with the second antenna panel.

In a twelfth aspect, alone or in combination with one or more of the first through eleventh aspects, antenna configurations supported by the multi-panel rank 5-8 Type-I codebook includes a first set of antenna configurations associated with 16 antenna ports and a second set of antenna configurations associated with 32 antenna ports, and the antenna configurations supported by the multi-panel rank 5-8 Type-I codebook excludes antenna configurations associated with 8 antenna ports.

In a thirteenth aspect, alone or in combination with one or more of the first through twelfth aspects, the multi-panel rank 5-8 Type-I codebook includes a co-phasing factor for each beam indicated in the multi-panel rank 5-8 Type-I codebook.

Although FIG. 52 shows example blocks of process 5200, in some aspects, process 5200 may include additional blocks, fewer blocks, different blocks, or differently arranged blocks than those depicted in FIG. 52. Additionally, or alternatively, two or more of the blocks of process 5200 may be performed in parallel.

FIG. 53 is a diagram of an example apparatus 5300 for wireless communication. The apparatus 5300 may be a UE, or a UE may include the apparatus 5300. In some aspects, the apparatus 5300 includes a reception component 5302 and a transmission component 5304, which may be in communication with one another (for example, via one or more buses and/or one or more other components). As shown, the apparatus 5300 may communicate with another apparatus 5306 (such as a UE, a base station, or another wireless communication device) using the reception component 5302 and the transmission component 5304. As further shown, the apparatus 5300 may include the communication manager 140. The communication manager 140 may include a determination component 5308, among other examples.

In some aspects, the apparatus 5300 may be configured to perform one or more operations described herein in connection with FIGS. 10-51. Additionally, or alternatively, the apparatus 5300 may be configured to perform one or more processes described herein, such as process 5200 of FIG. 52. In some aspects, the apparatus 5300 and/or one or more components shown in FIG. 53 may include one or more components of the UE described in connection with FIG. 2. Additionally, or alternatively, one or more components shown in FIG. 53 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 5302 may receive communications, such as reference signals, control information, data communications, or a combination thereof, from the apparatus 5306. The reception component 5302 may provide received communications to one or more other components of the apparatus 5300. In some aspects, the reception component 5302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 5300. In some aspects, the reception component 5302 may include one or more antennas, a modem, a demodulator, a MIMO detector, a receive processor, a controller/processor, a memory, or a combination thereof, of the UE described in connection with FIG. 2.

The transmission component 5304 may transmit communications, such as reference signals, control information, data communications, or a combination thereof, to the apparatus 5306. In some aspects, one or more other components of the apparatus 5300 may generate communications and may provide the generated communications to the transmission component 5304 for transmission to the apparatus 5306. In some aspects, the transmission component 5304 may perform signal processing on the generated communications (such as filtering, amplification, modulation, digital-to-analog conversion, multiplexing, interleaving, mapping, or encoding, among other examples), and may transmit the processed signals to the apparatus 5306. In some aspects, the transmission component 5304 may include one or more antennas, a modem, a modulator, a transmit MIMO processor, a transmit processor, a controller/processor, a memory, or a combination thereof, of the UE described in connection with FIG. 2. In some aspects, the transmission component 5304 may be co-located with the reception component 5302 in a transceiver.

The determination component 5308 may determine one or more parameters for a rank 5-8 Type-I codebook. The transmission component 5304 may perform, to a base station, a rank 5-8 CSI reporting based at least in part on the rank 5-8 Type-I codebook that includes the one or more parameters. The reception component 5302 may receive, from the base station, an indication of the one or more parameters for the rank 5-8 Type-I codebook.

The number and arrangement of components shown in FIG. 53 are provided as an example. In practice, there may be additional components, fewer components, different components, or differently arranged components than those shown in FIG. 53. Furthermore, two or more components shown in FIG. 53 may be implemented within a single component, or a single component shown in FIG. 53 may be implemented as multiple, distributed components. Additionally, or alternatively, a set of (one or more) components shown in FIG. 53 may perform one or more functions described as being performed by another set of components shown in FIG. 53.

The following provides an overview of some Aspects of the present disclosure:

Aspect 1: A method of wireless communication performed by a user equipment (UE), comprising: determining one or more parameters for a rank 5-8 Type-I codebook; and performing, to a base station, a rank 5-8 channel state information (CSI) reporting based at least in part on the rank 5-8 Type-I codebook that includes the one or more parameters.

Aspect 2: The method of Aspect 1, wherein the rank 5-8 Type-I codebook is a single-panel rank 5-8 Type-I codebook.

Aspect 3: The method of any of Aspects 1 through 2, wherein the one or more parameters for the rank 5-8 Type-I codebook include beam-specific co-phasing factors, wherein a co-phasing factor is defined for each beam indicated in the rank 5-8 Type-I codebook.

Aspect 4: The method of any of Aspects 1 through 3, wherein the one or more parameters for the rank 5-8 Type-I codebook include: a first co-phasing factor applied for a cross-polarization associated with the rank 5-8 Type-I codebook, and a second co-phasing factor applied for different antenna groups formed from a plurality of transmit antennas associated with the UE.

Aspect 5: The method of any of Aspects 1 through 4, wherein the one or more parameters for the rank 5-8 Type-I codebook include a first integer value and a second integer value to provide an angular distance between different beams, as indicated in the rank 5-8 Type-I codebook, that satisfies a threshold.

Aspect 6: The method of any of Aspects 1 through 5, wherein determining the one or more parameters for the rank 5-8 codebook further comprises receiving, from the base station, an indication of the one or more parameters for the rank 5-8 Type-I codebook.

Aspect 7: The method of any of Aspects 1 through 6, wherein determining the one or more parameters for the rank 5-8 codebook further comprises selected the one or more parameters for the rank 5-8 Type-I codebook at the UE.

Aspect 8: The method of any of Aspects 1 through 7, wherein the one or more parameters for the rank 5-8 Type-I codebook include a first codebook index, a second codebook index, and a third codebook index, wherein the first codebook index and the second codebook index are associated with a wideband channel and indicate a group of beams, and wherein the third codebook index is associated with a sub-band channel and indicates a beam selection from the group of beams.

Aspect 9: The method of Aspect 8, wherein the third codebook index is based at least in part on a quantity of antenna elements in a vertical domain.

Aspect 10: The method of any of Aspects 1 through 9, wherein the rank 5-8 Type-I codebook is a multi-panel rank 5-8 Type-I codebook.

Aspect 11: The method of Aspect 10, wherein the multi-panel rank 5-8 Type-I codebook is based at least in part on a concatenation of two or more single-panel rank 5-8 Type-I precoders with panel co-phasing factors.

Aspect 12: The method of Aspect 10, wherein: the multi-panel rank 5-8 Type-I codebook is associated with a first mode, wherein a same precoder is applied to different antenna panels based at least in part on the first mode; or the multi-panel rank 5-8 Type-I codebook is associated with a second mode, wherein a first precoder is applied to a first antenna panel and a second precoder is applied to a second antenna panel based at least in part on the second mode, wherein the first precoder and the second precoder apply a same beam for each polarization associated with the first antenna panel and the second antenna panel, and wherein the first precoder applies first co-phasing factors for cross polarizations associated with the first antenna panel and the second precoder applies second co-phasing factors for cross polarizations associated with the second antenna panel.

Aspect 13: The method of Aspect 10, wherein antenna configurations supported by the multi-panel rank 5-8 Type-I codebook includes a first set of antenna configurations associated with 16 antenna ports and a second set of antenna configurations associated with 32 antenna ports, and wherein the antenna configurations supported by the multi-panel rank 5-8 Type-I codebook excludes antenna configurations associated with 8 antenna ports.

Aspect 14: The method of Aspect 10, wherein the multi-panel rank 5-8 Type-I codebook includes a co-phasing factor for each beam indicated in the multi-panel rank 5-8 Type-I codebook.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
determine one or more parameters for a rank 5-8 Type-I codebook; and
perform, to a base station, a rank 5-8 channel state information (CSI) reporting based at least in part on the rank 5-8 Type-I codebook that includes the one or more parameters.

2. The apparatus of claim 1, wherein the rank 5-8 Type-I codebook is a single-panel rank 5-8 Type-I codebook.

3. The apparatus of claim 1, wherein the one or more parameters for the rank 5-8 Type-I codebook include beam-specific co-phasing factors, wherein a co-phasing factor is defined for each beam indicated in the rank 5-8 Type-I codebook.

4. The apparatus of claim 1, wherein the one or more parameters for the rank 5-8 Type-I codebook include: a first co-phasing factor applied for a cross-polarization associated with the rank 5-8 Type-I codebook, and a second co-phasing factor applied for different antenna groups formed from a plurality of transmit antennas associated with the UE.

5. The apparatus of claim 1, wherein the one or more parameters for the rank 5-8 Type-I codebook include a first integer value and a second integer value to provide an angular distance between different beams, as indicated in the rank 5-8 Type-I codebook, that satisfies a threshold.

6. The apparatus of claim 1, wherein the one or more processors, to determine the one or more parameters for the rank 5-8 codebook, are configured to receive, from the base station, an indication of the one or more parameters for the rank 5-8 Type-I codebook.

7. The apparatus of claim 1, wherein the one or more processors, to determine the one or more parameters for the rank 5-8 codebook, are configured to select the one or more parameters for the rank 5-8 Type-I codebook at the UE.

8. The apparatus of claim 1, wherein the one or more parameters for the rank 5-8 Type-I codebook include a first codebook index, a second codebook index, and a third codebook index, wherein the first codebook index and the second codebook index are associated with a wideband channel and indicate a group of beams, and wherein the third codebook index is associated with a sub-band channel and indicates a beam selection from the group of beams.

9. The apparatus of claim 8, wherein the third codebook index is based at least in part on a quantity of antenna elements in a vertical domain.

10. The apparatus of claim 1, wherein the rank 5-8 Type-I codebook is a multi-panel rank 5-8 Type-I codebook.

11. The apparatus of claim 10, wherein the multi-panel rank 5-8 Type-I codebook is based at least in part on a concatenation of two or more single-panel rank 5-8 Type-I precoders with panel co-phasing factors.

12. The apparatus of claim 10, wherein:
the multi-panel rank 5-8 Type-I codebook is associated with a first mode, wherein a same precoder is applied to different antenna panels based at least in part on the first mode; or
the multi-panel rank 5-8 Type-I codebook is associated with a second mode, wherein a first precoder is applied to a first antenna panel and a second precoder is applied to a second antenna panel based at least in part on the second mode, wherein the first precoder and the second precoder apply a same beam for each polarization associated with the first antenna panel and the second antenna panel, and wherein the first precoder applies first co-phasing factors for cross polarizations associated with the first antenna panel and the second precoder applies second co-phasing factors for cross polarizations associated with the second antenna panel.

13. The apparatus of claim 10, wherein antenna configurations supported by the multi-panel rank 5-8 Type-I codebook includes a first set of antenna configurations associated with 16 antenna ports and a second set of antenna configurations associated with 32 antenna ports, and wherein the antenna configurations supported by the multi-panel rank 5-8 Type-I codebook excludes antenna configurations associated with 8 antenna ports.

14. The apparatus of claim 10, wherein the multi-panel rank 5-8 Type-I codebook includes a co-phasing factor for each beam indicated in the multi-panel rank 5-8 Type-I codebook.

15. A method of wireless communication performed by a user equipment (UE), comprising:
determining one or more parameters for a rank 5-8 Type-I codebook; and
performing, to a base station, a rank 5-8 channel state information (CSI) reporting based at least in part on the rank 5-8 Type-I codebook that includes the one or more parameters.

16. The method of claim 15, wherein the rank 5-8 Type-I codebook is a single-panel rank 5-8 Type-I codebook.

17. The method of claim 15, wherein determining the one or more parameters for the rank 5-8 codebook further comprises receiving, from the base station, an indication of the one or more parameters for the rank 5-8 Type-I codebook.

18. The method of claim 15, wherein determining the one or more parameters for the rank 5-8 codebook further comprises selected the one or more parameters for the rank 5-8 Type-I codebook at the UE.

19. The method of claim 15, wherein the one or more parameters for the rank 5-8 Type-I codebook include beam-specific co-phasing factors, wherein a co-phasing factor is defined for each beam indicated in the rank 5-8 Type-I codebook.

20. The method of claim 15, wherein the one or more parameters for the rank 5-8 Type-I codebook include: a first co-phasing factor applied for a cross-polarization associated with the rank 5-8 Type-I codebook, and a second co-phasing factor applied for different antenna groups formed from a plurality of transmit antennas associated with the UE.

21. The method of claim 15, wherein the one or more parameters for the rank 5-8 Type-I codebook include a first integer value and a second integer value to provide an angular distance between different beams, as indicated in the rank 5-8 Type-I codebook, that satisfies a threshold.

22. The method of claim 15, wherein the one or more parameters for the rank 5-8 Type-I codebook include a first codebook index, a second codebook index, and a third codebook index, wherein the first codebook index and the second codebook index are associated with a wideband channel and indicate a group of beams, and wherein the third codebook index is associated with a sub-band channel and indicates a beam selection from the group of beams.

23. The method of claim 22, wherein the third codebook index is based at least in part on a quantity of antenna elements in a vertical domain.

24. The method of claim 15, wherein the rank 5-8 Type-I codebook is a multi-panel rank 5-8 Type-I codebook.

25. The method of claim 24, wherein the multi-panel rank 5-8 Type-I codebook is based at least in part on a concatenation of two or more single-panel rank 5-8 Type-I precoders with panel co-phasing factors.

26. The method of claim 24, wherein:
the multi-panel rank 5-8 Type-I codebook is associated with a first mode, wherein a same precoder is applied to different antenna panels based at least in part on the first mode; or
the multi-panel rank 5-8 Type-I codebook is associated with a second mode, wherein a first precoder is applied to a first antenna panel and a second precoder is applied to a second antenna panel based at least in part on the second mode, wherein the first precoder and the second precoder apply a same beam for each polarization associated with the first antenna panel and the second antenna panel, and wherein the first precoder applies first co-phasing factors for cross polarizations associated with the first antenna panel and the second precoder applies second co-phasing factors for cross polarizations associated with the second antenna panel.

27. The method of claim 24, wherein antenna configurations supported by the multi-panel rank 5-8 Type-I codebook includes a first set of antenna configurations associated with 16 antenna ports and a second set of antenna configurations associated with 32 antenna ports, and wherein the antenna configurations supported by the multi-panel rank 5-8 Type-I codebook excludes antenna configurations associated with 8 antenna ports.

28. The method of claim 24, wherein the multi-panel rank 5-8 Type-I codebook includes a co-phasing factor for each beam indicated in the multi-panel rank 5-8 Type-I codebook.

29. A non-transitory computer-readable medium storing a set of instructions for wireless communication, the set of instructions comprising:
one or more instructions that, when executed by one or more processors of a user equipment (UE), cause the UE to:
determine one or more parameters for a rank 5-8 Type-I codebook; and
perform, to a base station, a rank 5-8 channel state information (CSI) reporting based at least in part on the rank 5-8 Type-I codebook that includes the one or more parameters.

30. An apparatus for wireless communication, comprising:
means for determining one or more parameters for a rank 5-8 Type-I codebook; and
means for performing, to a base station, a rank 5-8 channel state information (CSI) reporting based at least in part on the rank 5-8 Type-I codebook that includes the one or more parameters.
